(19) United States
(12) Patent Application Publication
(10) Pub. No.: US 2012/0305664 A1
(43) Pub. Date: Dec. 6, 2012

(54) Everything genus and everything solutions

(76) Inventor: Svetozar B. Petrovich, Chicago, IL (US)

(21) Appl. No.: 13/506,098

(22) Filed: Mar. 27, 2012

Related U.S. Application Data
(63) Continuation-in-part of application No. 13/136,140, filed on Jul. 25, 2011.
Application No. 13/136,140 is a continuation-in-part of application No. 13/135,617, filed on Jul. 11, 2011.
Application No. 13/135,617 is a continuation-in-part of application No. 13/068,587, filed on May 16, 2011.
Application No. 13/068,587 is a continuation-in-part of application No. PCT/US2010/001379, filed on May 10, 2010.
Application No. PCT/US2010/001379 is a continuation-in-part of application No. 12/658,099, filed on Feb. 1, 2010, now abandoned.
Application No. 12/658,099 is a continuation-in-part of application No. PCT/US2010/000187, filed on Jan. 25, 2010.
Application No. PCT/US2010/000187 is a continuation-in-part of application No. PCT/US2010/000188, filed on Jan. 25, 2010.
Application No. PCT/US2010/000188 is a continuation-in-part of application No. 12/453,444, filed on May 12, 2009, now abandoned.
Application No. 12/453,444 is a continuation-in-part of application No. 12/382,448, filed on Mar. 17, 2009, now abandoned.
Application No. 12/382,448 is a continuation-in-part of application No. 12/320,441, filed on Jan. 26, 2009, now abandoned.
Application No. 12/320,441 is a continuation-in-part of application No. 12/320,440, filed on Jan. 26, 2009, now abandoned.
Application No. 12/320,440 is a continuation-in-part of application No. 12/153,036, filed on May 13, 2008, now abandoned.
Application No. 12/153,036 is a continuation-in-part of application No. 11/809,132, filed on May 31, 2007, now abandoned.
Application No. 11/809,132 is a continuation-in-part of application No. 11/807,748, filed on May 30, 2007, now abandoned.
Application No. 11/807,748 is a continuation-in-part of application No. 11/788,172, filed on Jun. 4, 2007, now abandoned.
Application No. 11/788,172 is a continuation-in-part of application No. 11/724,752, filed on Mar. 15, 2007, now abandoned.
Application No. 11/724,752 is a continuation-in-part of application No. 11/809,132, filed on May 31, 2007, now abandoned.
Application No. 11/809,132 is a continuation-in-part of application No. 11/807,748, filed on May 30, 2007, now abandoned.
Application No. 11/807,748 is a continuation-in-part of application No. 11/504,304, filed on Aug. 14, 2006, now abandoned.
Application No. 11/504,304 is a continuation-in-part of application No. 11/385,078, filed on Mar. 20, 2006, now abandoned.
Application No. 11/385,078 is a continuation-in-part of application No. 11/418,157, filed on May 3, 2006, now abandoned.
Application No. 11/418,157 is a continuation-in-part of application No. 11/342,006, filed on Jan. 30, 2006, now abandoned.
Application No. 11/342,006 is a continuation-in-part of application No. 11/233,546, filed on Sep. 23, 2005, now abandoned.
Application No. 11/233,546 is a continuation-in-part of application No. 11/212,943, filed on Aug. 25, 2005, now abandoned.
Application No. 11/212,943 is a continuation-in-part of application No. 11/188,339, filed on Jul. 25, 2005, now abandoned.
Application No. 11/188,339 is a continuation-in-part of application No. 11/028,982, filed on Jan. 3, 2005, now abandoned.
Application No. 11/028,982 is a continuation-in-part of application No. 10/869,752, filed on Jun. 16, 2004, now abandoned.
Application No. 10/869,752 is a continuation-in-part of application No. 10/840,152, filed on May 5, 2004, now abandoned.
Application No. 10/840,152 is a continuation-in-part of application No. 10/742,485, filed on Dec. 19, 2003, now abandoned.
Application No. 10/742,485 is a continuation-in-part of application No. 10/190,993, filed on Jul. 8, 2002, now abandoned.
Application No. 10/190,993 is a continuation-in-part of application No. 10/156,192, filed on May 28, 2002, now abandoned.
Application No. 10/156,192 is a continuation-in-part of application No. 10/074,966, filed on Feb. 13, 2002, now abandoned.
Application No. 10/074,966 is a continuation-in-part of application No. 09/850,927, filed on May 8, 2001, now abandoned.
Application No. 09/850,927 is a continuation-in-part of application No. 09/518,884, filed on Mar. 6, 2000, now abandoned.
Application No. 09/518,884 is a continuation-in-part of application No. 09/376,957, filed on Aug. 18, 1999, now abandoned.
Application No. 09/376,957 is a continuation-in-part of application No. 10/195,668, filed on Jul. 15, 2002, now abandoned.
Application No. 10/195,668 is a continuation-in-part of application No. 10/073,914, filed on Feb. 14, 2002, now abandoned.
Application No. 10/073,914 is a continuation-in-part of application No. 09/376,957, filed on Aug. 18, 1999, now abandoned.
Application No. 09/376,957 is a continuation-in-part of application No. 08/950,898, filed on Oct. 15, 1997, now Pat. No. 5,941,273.
(60) Provisional application No. 60/231,514, filed on Sep. 9, 2000.
(60) Provisional application No. 60/223,750, filed on Aug. 8, 2000.
(60) Provisional application No. 60/220,358, filed on Jul. 24, 2000.
(60) Provisional application No. 60/217,308, filed on Jul. 11, 2000.
(60) Provisional application No. 60/123,504, filed on Mar. 9, 1999.
(60) Provisional application No. 60/123,207, filed on Mar. 8, 1999.
(60) Provisional application No. 60/123,153, filed on Mar. 6, 1999.
(60) Provisional application No. 60/123,504, filed on Mar. 9, 1999.
(60) Provisional application No. 60/123,207, filed on Mar. 8, 1999.
(60) Provisional application No. 60/123,153, filed on Mar. 6, 1999.

(51) Int. Cl. A01G 15/00

(52) U.S. Cl. 239/14.1

(57) ABSTRACT

An Advanced Processor magma, mantle function and magnetic field lines couple mantle-coupled groundwater, polar caps and glaciers, less couple oceans with continental waters, partly decouple atmospheric fluids and least couple ionosphere ions and electrons mass, in magnetosphere bound compositions mass of light fluids quanta; light fluids magnetosphere perfect boundaries mass and energy highest conserving (MEHC) quintessential core natural disposition (QCNDMEHC) yields boundaries complete compliments, stressed by volume changes energy of distortion; bound mass fluid compositions force stratifications, gradations, and forbidden mechanisms, to distort, deform and distend dispositions of perfect boundaries complete complements and force Jean's fountains, forbidden mechanisms plasma outflows; innovations, inventions, principles, methodologies, Ions and Isotopes (FEIIPMII), genus Fluid Elements and the Advanced Processor, by quantum energy spawn perfect boundaries and sui generis boundaries, in high technologies algorithms computing principles, methodologies, innovations, and inventions (PMII), boundaries perfection tracings for globose conduit Sets, as in Advanced Processors, Advanced Fluid Elements.

This application is a continuation in part of these applications:

Ser. No. 13/136,140 Jul. 25, 2011 and
Ser. No. 13/135,617 Jul. 11, 2011 and
Ser. No. 13/068,587 May 16, 2011 and

### PCT/US210/001379 May 10, 2010 and

Ser. No. 12/658,099 Feb. 10, 2010 and

### PCT/US210/000187 Jan. 25, 2010 and

### PCT/US210/000188 Jan. 25, 2010 and

Ser. No. 12/453,444 May 12, 2009 and,
Ser. No. 12/382,448 Mar. 17, 2009 and
Ser. No. 12/320,441 Jan. 26, 2009 and
Ser. No. 12/320,440 Jan. 26, 2009 and
Ser. No. 12/153,036 May 13, 2008 and
Ser. No. 11/809,132 May 31, 2007 and
Ser. No. 11/807,748 May 30, 2007 and
Ser. No. 11/788,172 Jun. 4, 2007 and
Ser. No. 11/724,752 Mar. 15, 2007 and said
Ser. No. 11/809,132 May 31, 2007 and said
Ser. No. 11/807,748 May 30, 2007 and said
Ser. No. 11/788,172 Jun. 4, 2007 and
Ser. No. 11/504,304 Aug. 14, 2006 and
Ser. No. 11/385,078 Mar. 20, 2006 and said
Ser. No. 11/724,752 Mar. 15, 2007 and
Ser. No. 11/418,157 May 3, 2006 and
Ser. No. 11/342,006 Jan. 30, 2006 and
Ser. No. 11/233,546 Sep. 23, 2005 and
Ser. No. 11/212,943 Aug. 25, 2005 and
Ser. No. 11/188,339 Jul. 25, 2005 and
Ser. No. 11/028,982 Jan. 3, 2005 and
Ser. No. 10/869,752 Jun. 16, 2004 and
Ser. No. 10/840,152 May 5, 2004 and
Ser. No. 10/742,485 Dec. 19, 2003 and
Ser. No. 10/190,993 Jul. 8, 2002 and
Ser. No. 10/156,192 May 28, 2002 and
Ser. No. 10/074,966 Feb. 13, 2002 and
Ser. No. 09/850,927 May 8, 2001 and
Ser. No. 09/518,884 Mar. 6, 2000 and
Ser. No. 09/376,957 Aug. 18, 1999 and said
Ser. No. 10/869,752 Jun. 16, 2004 and said
Ser. No. 10/840,152 May 5, 2004 and said
Ser. No. 10/156,192 May 28, 2002 and said
Ser. No. 10/074,966 Feb. 13, 2002 and said
Ser. No. 09/850,927 May 8, 2001 and said
Ser. No. 09/518,884 Mar. 6, 2000 and said
Ser. No. 09/376,957 Aug. 18, 1999 and said
Ser. No. 10/869,752 Jun. 16, 2004 and
Ser. No. 10/195,668 Jul. 15, 2002 and
Ser. No. 10/073,914 Feb. 14, 2002 and said
Ser. No. 09/850,927 May 8, 2001 and said
Ser. No. 09/518,884 Mar. 6, 2000 and said
Ser. No. 09/376,957 Aug. 18, 1999 and said
Ser. No. 10/742,485 Dec. 19, 2003 and said
Ser. No. 10/156,192 May 28, 2002 and said
Ser. No. 10/190,993 Jul. 8, 2002 and said
Ser. No. 10/073,914 Feb. 14, 2002 and said
Ser. No. 10/074,966 Feb. 13, 2002 and said
Ser. No. 09/850,927 May 8, 2001 and said
Ser. No. 09/518,884 Mar. 6, 2000 and said
Ser. No. 09/376,957 Aug. 18, 1999 and said
Ser. No. 09/850,927 May 8, 2001 claims benefit of
60/231,514 Sep. 9, 2000 and claims benefit of
60/226,750 Aug. 21, 2000 and claims benefit of
60/220,358 Jul. 24, 2000 and claims benefit of
60/217,308 Jul. 11, 2000 and said
Ser. No. 09/518,884 Mar. 6, 2000 (contains said Ser. No. 09/376,957 Aug. 18, 1999) and claims benefit of
60/123,504 Mar. 9, 1999 and claims benefit of
60/123,207 Mar. 8, 1999 and claims benefit of
60/123,153 Mar. 6, 1999 and said
Ser. No. 09/376,957 Aug. 18, 1999 and claims benefit of
60/123,504 Mar. 9, 1999 and claims benefit of
60/123,207 Mar. 8, 1999 and claims benefit of
60/123,153 Mar. 6, 1999 and said
Ser. No. 09/376,957 Aug. 18, 1999 and
Ser. No. 08/950,898 Oct. 15, 1997, U.S. Pat. No. 5,941,273

### BACKGROUND OF THE INVENTION

Energy issues, water conservation, AGW and sciences enormously important theories are solved.

Novelty of a truly revolutionary inventions reside in one or more of these innovation domains: a) forms equal functions; b) functions equal forms; c) science; and d) God's forbidden mechanisms; the Laws of Mass and Energy Conservation governs said domains. True, revolutionary scientific discovery or disclosure must reside in all real domains, especially the d domain; a device novelty must commend inventive presence in evolving light fluids mass energy, said Laws and domain d.

Newton in discovering the gravitational force expressed discomfort in his model of the Universe; Albert Einstein mathematics nearly discover gravitational field causal properties but then regress. Likewise, Charles Darwin theories of evolution detailed scientific many conclusions raise issues. Nikola Tesla's discoveries, among numerous innovations, clearly transcend across said domains; Milutin Milankovich's revolutionary scope of ice ages theory compiles transcending factual data.

The United Nation's International Panel on Climate Change (IPCC) exhaustive, scientific studies reach consensus on global warming disputable symptoms cooperative environmental regulations, focusing primarily on controlling carbon dioxide releases into the atmosphere, as the green house gases main culprit based on detailed geophysical observations; such global warming scope forces exhaustive geophysical observations, in governments global control of crucial survival processes, raises global skepticisms, and discords, which governmental actions acknowledge; governmental regulations creativity, as a science novelty, unless proven to belong in innovating and universally commanding domain d, constitute forced, incomplete, herein shown transient misleading options.

Astronomical observations ascertain appreciations for the Universe sui generis fluid sciences; the Solar system most planets crust couple fluids into frozen mass formations, during glacial periods, and then at least partly decouple those fluids, during interglacial periods; the Earth Jean's plasma fountains phenomena also emit ions into space, decoupling the ions plasma from the atmosphere.

The Earth's geology interglacial and glaciation epochs affirm crucial dispositions of ice caps and glaciers. The dispositions embody undeniable evidence that the Earth lost enormous water mass. Sciences disclosed global air warming root causes reveal human secular anthropogenic behavior.

The prior art technologies egocentrically presume simplifications or constraints that compromise the entire prior art fluid mechanics, comprising key fluid devices deeply flawed applied sciences.

Disclosing global air warming root causal effects reveals human secular anthropogenic behavior. The prior art technologies egocentrically presume simplifications or constraints, which permeate the entire prior art fluid mechanics, comprising key fluid devices deeply flawed applied sciences.

### SUMMARY OF THE INVENTION

An Advanced Processor magma, mantle function and magnetic field lines couple mantle-coupled groundwater, polar caps and glaciers, less couple oceans with continental waters, partly decouple atmospheric fluids and least couple ionosphere ions and electrons mass, in magnetosphere bound compositions mass of light fluids quanta; light fluids magnetosphere perfect boundaries mass and energy highest conserving (MEHC) quintessential core natural disposition (QCNDMEHC) yields boundaries complete compliments, stressed by volume changes energy of distortion; bound mass fluid compositions force stratifications, gradations, and forbidden mechanisms, to distort, deform and distend dispositions of perfect boundaries complete complements and force Jean's fountains, forbidden mechanisms plasma outflows; innovations, inventions, principles, methodologies, Ions and Isotopes (FEIIPMII), genus Fluid Elements and the Advanced Processor, by quantum energy spawn perfect boundaries and sui generis boundaries, in high technologies algorithms computing principles, methodologies, innovations, and inventions (PMII), boundaries perfection tracings for globose conduit Sets, as in Advanced Processors, Advanced Fluid Elements; genus genres shown boundaries yield the suit generis boundaries and genres of genus that constitutes domains of Sets. Fundamental Fluid Elements and the Fluid Elements comprising the sui generis boundaries and a ubiquitous clustering of the sui generis boundaries own solely key means for crucial reliefs, from global energy demands, water depletions, and innate and anthropogenic global warming (AGW). The FEIIPMII with the PMII and the Fluid Elements in clusters spawns means for combating the magnetic field lines recurring disconnects at shoulders of cusps that innately experience suctions.

The Earth's fluids evolve forms equal function anion bulb, laminar, globose boundaries stratified sustained fluids; gravitational sink and magnetic field shield molecular, atomic and plasma fluids bounded by the magnetosphere boundaries enormous fluxing which is highly forced by the Solar and cosmic wind pressures and radiations. The MEHC, PMII technologies, in conforming fluids least mass energy transport functions and processes, yield the sui generis boundaries of said Sets; the Universe functions and functions of the entire prior art constitute fundamental confrontations.

In the magnetic field, applied science true technologies must conform to the Universe—functions equal forms with forms equal functions—that drive and balance the Universe critical imbalances; sciences true technologies must first and foremost entirely conform to said Laws of the Universe; the prior art does not even conform to the Earth's functions, creating ubiquitous longevity issues; aforesaid briefly summarizes global air warming root causal effects that threaten this civilization.

A least energy of distortion of Fluid Elements fluid systems constitutes least fluids quanta energy equal to quantum units simultaneous paths of passage (PP) lengths least sum (PPLLS) that forces mass energy highest conserving (MEHC); analogously, the MEHC constitutes PP lengths tensors and gravitational field highest effects in two vertical directions and none in the other four. Fluids crucial quanta centric genres of quintessential core (QC) which broaden natural disposition (ND) atmospheric conditions comprise QCNDMEHC energy. A fluid MEHC paths directional change transfers energy portion into detrimental energy of distortion that diminishes boundary longevity.

Newton's discovery of gravity, through a fallen apple from a tree, disregards one key effect; after the apple confirms the Earth's, the Advanced Processor, fluids coupling by mass energy, wherein allowed to dry under the Sun's radiations, said apple looses its water fluids to the atmosphere. In a partial decoupling from crustal masses, the apple vaporized fluids rise to sufficient altitude, and water mass portion under excitations of the Sun's radiations energy breaks into oxygen hydrogen ions energy; the hydrogen ions escape the Earth's the electromagnetic field and gravitational sink by forbidden mechanisms decoupling processes; the Jean's fountain outflow plasma mass energy consists of nitrogen, oxygen and hydrogen ions which squirt through electromagnetic field cusps. The Shell Theory, Newton at al, misses on light fluids mass energy term—ions decoupling effects reaction to global air warming, as the Advanced Processor, the Earth, innately utilizes light fluids mass energy to alleviate the magnetosphere, magnetic field outermost lines boundaries perfection energy demands; that, with global energy demands emitting light fluids, imperils our civilization.

Thus the Newton's Shell Theory misses a term integral of mass energy transport from “the shell” to Black Hole, ensuing from the Big Band event to present. At a specific time, instance ‘t’ fluids mass energy transports from the shell to disposed centric Black Hole constitutes light fluids mass energy demands of Black Hole. Gauss's elegant Shell Theory computations likewise missed said fluids mass energy transports. Pure mathematical science cannot predict causal effects forcing of forbidden mechanisms none zero possibility events; Einstein came up with universe gravitational constant, to call it a great blunder; purely mathematical theories are known to contain deep flaws.

Einstein did not account for the forbidden mechanisms hydrogen escape from the Earth's mass or similar Nitrogen and Oxygen escapes, plasma fountains commonly called as Jean's fountains and missed on the Black Hole function, even if he anticipated its existence, thus, was also unaware of Black Hole light fluids energy demand; Einstein misses the Theory of Uniformity that subdivides the Universe mass energy in—forms equal functions—optimal processes that unify all light fluids dynamics, thermodynamics, and atomic energy, magnetic fields and gravitational sinks forced by the Laws of Mass and Energy Conservation; the Universe fluids mass energy delineated building blocks unify atomic elements into Galactic bodies that effect planets evolving of crustal surfaces; In the Universe, Advanced Fluid Elements respective boundaries unify mass energy into celestial bodies lowest potential, if needed through forbidden mechanisms; within the magnetic field, light fluid densities evolve MEHC gravitational sink functions spawned lowest potential levels and the Advanced Fluid Elements, the Advanced Processors, boundaries perfection paradigms comprised planets by functions equal forms; Processes of stratifications, gradations remove light fluid from compounds; the vapors thru forbidden mechanisms transfer into plasma outflows of the magnetic field cusps, effectuating the Earth mass energy lower potential levels. The Theory of Uniformity solution unifies the past, the present and in the future mass and energy fluids evolving, balancing and sustaining boundaries perfection, effectuated by Black Hole light fluids mass energy demand that effects transporting of galactic light fluids streaming continuum and balancing of everything.

The acceptance of the Theory of Relativity, with all research conducted since its inception, never explained glacial periods root causes, enormous water fluids disappearance from the period when the Earth was ice covered. And, one more thing—failed to reveal fluid compositions conforming functions least quanta mass boundaries perfection; disclosures here change that, with much more.

For planets and stars mass fluids energy, polarity constitutes a sink and a source. Taking the Sun radiations relatively constant within 0.1-0.2%, in the last 2000 years, the Milky Way Galaxy and galaxies in general retain relatively constant polarity and respective mass energy demands, which is most deceiving when mass energy demands last for billions of years; in forbidden mechanisms realm, the polarities may switch—a planet becomes a source or a star becomes a sink, with fluids mass and energy higher densities dominating forbidden mechanism processes forced boundary; a gravitational sink, gravity force, comprises fluids mass energy evolution quests, seeking a lowest potential, mass energy sink, which totted up includes properties of celestial dynamics in common cause search for the Universe mass energy balance, only achievable with forced lowest potentials of light fluids mass and energy. When two bodies, with celestial dynamics do not merge, portion of their dynamics and mass energy changes delicate mass and energy balance toward lowering of evolving potential sinks of the two bodies. Normally, a planet mass energy sink avoids loosing a part of its mass even if subatomic, which requires polarity switch in forbidden mechanisms and a forcing of a source mass energy functions; A polarity switching tests celestial dynamics wherein bodies merge or separate more, illustrating mass energy evolutions incredibly balanced Universe.

Said FEIIPMII reveal technologies in the Universe of fluids energy utilization maximal functions that comprise globose, also referred to perimeter, spherical boundaries that enclose solids, liquids and gaseous light fluids mass energy. Said globose, spherical boundaries constitute the Universe fluids maximal mass energy forms evolving thru billions of years of light fluids energy dynamics pursuit of boundaries perfection and lowest potential sinks. Quantum mass and energy of quanta travels a straight path, unless altered by energy source, and also transfers from one celestial body to another in least energy demand directional path. Light fluids mass energy quantum paths thru billions of years and infinite repetitions trace the Universe fluids energy evolution of said perfect boundaries and delineations of the Advanced Processors, which also undeniably affirm the PMII.

Said Advanced Processors energy of distortion and volume changes constitute entirely conserved energy frictionless light fluids plasma QCNDMEHC flows that sustain structures of the Universe celestial globose form bodies, also often referred to as spherical. Celestial bodies and boundaries evolve mass energy-level forms, functions and longevity genres of the Advanced Fluid Elements. Light fluids continuum continuous transport streamlining and Black Hole fluids mass and energy gravitational lowest sink force evolution of the boundaries. Fluids, liquids and Isotopes and Ions plasma, the MEHC, QCNDMEHC and a QCMEHC respective genres high technologies generate perfect boundaries and fluid quanta flow volume change and energy of distortion fewest failures; liquid, liquid-vapor, and plasmas spawn the MEHC, QCMEHC, and QCNDMEHC, respectively;

A sui generis boundaries flux of fluxing fluid quanta achieves fluid boundaries perfection and sui generis boundaries means for flowing fluids and solids fluid in Second, First Fluid Elements with respective drain traps, lines functioning and embodying the fluid quanta: least volume limit and a short height, short length surface areas smallest sum, free surfaces area maximal sum, hydrostatic light pressures, and completely matching complete complements of globose-conduit (GC) forms, at highest elevations; quantum mass and energy subdivides said quanta, constituting—concurrent quantum energy tracings of paths of passage (PP), deriving a PP least sum (PPLLS); a path angle of passage (PAP) Line comprising an angle of less than 180′; and lowest path of passage, path of passage of least energy demand, a PPLD, a PPLD band comprising forms, a mass energy highest conserving (MEHC) and the fluxing fluid quanta with sui generis boundaries and a film layer, an inductive component, on inner surfaces of Sets as the sui generis boundaries an interface with the quanta. In globose domain, a Set comprises—a fluid Inlet capable of inflowing fluid, a basin and an outlet and means for retaining fluid; a lower end of the Inlet, an End 2; an End 2 undersurface, disposed in the quanta; an upper end, an End 1 of the Inlet; and said outlet capable of discharging fluid thru an outflow, a Second End, of the outlet. In globes inverse domain, a Set comprises—a fluid Inlet capable of inflowing fluid, a basin, and an outlet and means for retaining fluid; a lower end of the Inlet, an End 2, a basin, outlet form an upper end; an End 1, an upper end of said Inlet; in said basin, a front end, a First End, of the outlet; and an undersurface of the First End disposed in the quanta, the outlet capable of discharging fluid thru an outflow, a Second End, of the outlet. A globose and circumferential strains hybrid domain mutations, migrations Set comprises—a fluid Inlet capable of inflowing fluid, a basin, an outlet and means for retaining fluid; an upper end, an End 1, and a lower end, an End 2, of said Inlet; a front end, a First End, and an outflow, a Second End, of the outlet capable of discharging fluid; and in the quanta, disposed an undersurface of the End 2 or the Second End, and migrations, mutations matched genres of said strains in the Set. In domain, the undersurface in the quanta, without said film layer, comprises the fluid fluxing fluids retention free surface lowest level and the limit of the quanta least volume; a summit in the outlet constitutes means for retaining the fluid and the fluids entire quanta associated in retention, in the Inlet, the basin, and the outlet; flow energy surface dispensing (FESD) surfaces and FESD forms, comprising flow control means and including the film layer, lower the PPLLS; the PPLLS lowest sum comprises genome. The sui generis boundaries as surfaces, in an upright plane cross-section bound breadths of a nominal rounded lower area, widening breaths of a transition region area and wide breadths of a rounded upper area comprise a cross-section boundary of said Sets, drain lines respective forms. Said undersurface comprises means for precluding a gas venting thru the Inlet. The First and the Second Fluid Elements comprising Fluid Elements fundamental Fluid Elements possess means for venting gases inside the basin, comprising a venting line or a substitute device that positively precludes suction of the fluid that constitutes said least volume limit of the quanta.

The art of computer algorithms modeling of fluids and structure construction technologies genres comprise means for fabricating the sui generis boundaries of the fundamental Fluid Elements and the Fluid Elements, including the fluid and interfacing surfaces respective boundary layer genres; fluids least quanta forcing functions finite elements computing exactitudes defines the sui generis boundaries in highest resolution, which in resolutions utilization correlates with quantum energy. The PMII disclose the fluid boundaries perfection and the sui generis boundaries universal genus genres in the Advanced Processor in the fundamental Fluid Elements and in the atomic elements.

The genus genres, in clustering of the Fluid Elements, open up entire field of crucial innovations. The drawings disclose Sets and forms which are determinant, to finite elements resolution, which constitutes enormously more precise structures than those of the prior art. Said MEHC and least energy of distortion effect relationships, inducing said sui generis boundaries respective structure stresses and strains multiples least sum: Sets and forms maximal longevity genres and structures.

Said domains, in GC MEHC genus Universe said fluid boundaries perfection and said sui generis boundaries of globose and globose-cylindrical conforming embodiments, said Sets, constitute the fluid quanta at rest height less than two diameters of a cylindrical form that embodies the quanta.

Said fluid spawned Sets, wherein the End 2 or the First End undersurface lodged in the quanta, inside the basin, distinguishes among the Sets and domains. Symmetry of said basin or the outlet in a curved upright surface distinguishes hybrid Sets and mutations in globose or globose inverse domain; a disposition of the undersurface in the basin likewise differentiates Sets within domain. A Holding Chamber of the outlet, comprising means for inflowing the fluid from FESD forms of the outlet and capable of catching transient retention of the fluid and capable of the fluid outflow, distinguishes Industrial Sets. An Inlet conical FESD duel form, a part of the outlet, distinguishes Inline Sets. Dispositions of the End 1 in respect to the basin further distinguish Sets, and relative magnitudes of constituted respective angles of the PAP Line distinguish among angled Sets, also.

The Sets in said three domains, comprising fluids distribution system of a Flush Apparatus embedded in walls of structure associated with said sui generis boundaries, avoid interconnecting fittings, by welding of said structure molded parts with embedded interconnecting portions of the Flush Apparatus, thus assembling the Flush Apparatus and the structure of a Set. A tie-in or a set of tie-ins, accessibly disposed on the structure and outer threaded to receive a compression fitting which connects a Flush Apparatus fluid supply line to a tie-in apparatus that comprises means for delivering specifically designed fluids to the Flush Apparatus at selected flow rates and pressures and in preselected quantities. The means comprise check valve, control valve means that prevent potential of a fluid backflow; the Flush Apparatus, inside the Set, comprises means for the design fluids rinsing, flushing and servicing of the film layer of the sui generis boundaries, comprising a nozzle, a set or a network of nozzles, of spraying variety, disposed face flush with the sui generis boundaries except for illustrated major nozzles, which are all operated from said tie-in apparatus.

Said End 1 and said Second End, comprising a short length connections and any known in the art compression couplings, threaded and welded fittings, positively affix said End 1 to source of said fluid and the Second End to a draining line in assembling of the Set into a draining system. High pressure plastic moldings and material composites and metals of adequately rigid and semi-rigid, stiffened materials, and high precision fabrications and machining comprise said Sets fabrication.

The light fluids constituted high technology of globose-spherical conduit perimeter boundaries in the Advanced Processors plasma mass energy media magnetosphere sustained perfect boundaries transfers to globose conduit domains of molecular light fluids mass and energy Sets and forms of the Fluid Elements, effecting the MEHC and the sui generis boundaries; the Advanced Processor high technologies transfer to sui generis boundaries clustering, MEHC versions, comprising high technologies electromagnetic fluid devices, at exigent incongruous interfaces at boundaries of the sui generis boundaries and buildings structure, energy sealed said interfaces to longest longevity.

The Advanced Processor embodied magnetic field, genesis of the atomic elements, and the Fluid Elements quantum energy algorithms computed sui generis boundaries constitute genus universal genres universal correlations delineated from origins of the genres. In such correlations, the PAP line, with no intersection, is tangent to said PPLD band and globose Set End 2 or globose inverse Set First End of respective Fluid Element, in the three dimensional gravitational field that is seen locally as two directional; the Advanced Processor boundaries perfection, deforming under Solar and cosmic wind pressures and radiations, spawns two PPLD bands shortest length paths, on said magnetic field magnetic lines formed an innermost surface of the cusps, in the gravitational field six directions. Two shortest lines, PAP Lines, extending from the epigene and each tangent to its PPLD band in each cusp, at top of the troposphere, correlate genres in genus. In the gravitational field, and two and three dimensional effects respective two, six directions correlate the End 2 and the epigene; said PAP Line tangent points in each cusp yield funnel cross-section disposition and correlate in genus genres of the Advanced Processors magnetosphere magnetic fields universally evolving boundaries and said fundamental Fluid Elements fluxing of said sui generis boundaries.

wherein the Earth and the magnetosphere mass energy fluids constitute that Advanced Processor, of evolving mass energy thru billions of years, spawned magnetic field functions that shield light fluids quanta comprising: light ions and isotopes and molecular fluids and living organisms mass densities that effect magnetic field lines two magnetic poles formed two funnel cusps through the ionosphere and electrically charged stratosphere; the magnetic field lines constitute a GC globose inverse offset centric Set perfect boundaries that flux violently under Solar and cosmic radiations and wind pressures; frictionless flowing fluids in the cusps in one of two funnel directions spawn each cusp functions either as an open mouth branch Inlet or an orifice outlet jointly or separately, in perfect boundaries retained plasma densities causal effects response to said pressures; the cusp shoulders constitute forms of the End 1 or the Second End, depending on plasma flows direction. In situ, the Fluid Elements spawn completely matching complete complements, GC Sets, and the clustering of the sui generis boundaries effect light fluid genres, in revolutionary fluid mechanics quantum energy aspects tracing replicas of said magnetosphere perfect boundaries and longevity.

Prior applications reveal the FEIIPMII, MEHC and uniquely configured high technology nuclear plant Fluid Elements unique clusters of successive perimeter boundaries, constituting millennium longevity construction, sustained by uniquely configured electromagnetic fluid devices that assist the Earth's Advance Processor magnetosphere in sustenance of light fluids perimeter boundaries. The FEIIPMII, PMII and an earliest possible opportunity abandoned fossil fuel generation, replaced by nuclear super plants (SP), avoid forbidden mechanisms effectuating the ionosphere blow offs. The MEHC versions and said clustering effectuated fluid boundaries least volume change energy of distortion and electromagnet devices energy of distortion constitute configurations millennium longevities, perimeter boundaries unique structures, with unique principal strain theory of failure, constituting crucial deforming, in the sui generis boundaries, sustained by electromagnetic fluids.

This application, with the listed priority data applications, compiles and validates undeniable key evidence that the FEIIPMII, PMII, and MEHC versions comprise high technology universal fluid mechanics revolutionary true innovations that constitute our civilization only chance for survival. The civilizations recourse constitutes en mass implemented the FEIIPMII, PMII, and MEHC true and revolutionary devices technology and principles, methodologies, innovations and inventions.

All energy generating prior art construction technologies are defunct, useless and detrimental in confronting suction by Black Hole(s), as such art releases light fluids mass and energy into the atmosphere, distend the Earth fluids successive and crucial boundaries, and globally raise air temperatures; the MEHC conforming fluids least quanta, PMII FEIIPMII technology least energy of distortion and volume change devices yield maximal longevities of globose conduit boundaries and clustering of boundaries that retain most of fluids embodied mass and energy;

The Fluid Elements, the SP in the FEIIPMII combat, oppose scramble stratifications, gradations forbidden mechanisms processes; consequently the Earth's strongest magnetic field is a must do; Black Holes QCNDMEHC streaming energy demand and magnetic fields gravitational sinks rule the Universe by mass energy densities forcing dominance at confronting perimeter boundaries of mass energy gravity sinks minima, maxima functions—the QCNDMEHC conforming least mass forced forms equal functions, functions equal forms, evolving globose, spherical celestial bodies; the Earth magnetic field voluminous ionosphere obscures fluids energy decoupling with outflows of most valuable light fluids—nitrogen and water based ions plasma outflows; strongest magnetic field and the atmosphere, ionosphere fluids energy least volume densest boundaries is forced and a true must; the FEIIPMII and PMII technologies synchronous GC Sets operations with the Earth Advanced Processor and the SP transfers of heat energy that deflate distending of magnetosphere perfect boundaries, thus shielding the Earth fluids, comprise this civilization survival true option.

It is inexcusable for common sense and especially the scientific communities to conclude that the Earth's atmosphere configurations are uniquely stable source of light fluids mass and energy; the applications materially stress astronomical observations and geologic evidence which disprove it. Celestial bodies first and foremost constitute Fluid Elements mass energy that evolves respective clusters of light fluids boundaries, Galaxies with Black Holes mass energy perimeter boundaries, by universal QCNDMEHC mechanics highest resolutions, for light fluids potential energy lowest levels. AGW is a very small fraction of innate processes, forcing functions, which decouple light fluids mass and energy from the Earth's mantle. That reveals enormously important mass energy Advanced Processors and Fluid Elements evolving Universe, fluid mechanics high technology of Advanced Fluid Elements, celestial bodies, innately evolving light fluids lowest potential energy, forced energy levels, by Galaxies and Black Holes light fluids continuum transmitted demand for energy. Said Advanced Processors, MEHC spawn stratifications and gradations processes which seek fluids potential energy lowest levels. With said continuum steady flows, the survival of this civilization resides in said FEIIPMII, PMII and said perfect boundaries, solution of the Theory of Uniformity, with true revolutionary technologies that maximally secure light fluid crucial quanta and crucial compositions, by coupling water vapors precipitation into groundwater lowest energy potential level. Plasma densities lightest ions balance the Earth Advanced Processor fluids mass, the atmosphere's warming and light fluids continuum universal demand issues. It is conclusively true—light fluids evolve configurations of innate perfect boundaries disposition. Newton et al, in deeply flawed Shell Theory, miss on light fluids mass energy lowest potential energy level sinks, continuum functions, existences of evolving highly dynamic perfect boundaries and balancing of everything in the Universe; boundaries fluxing enormous amplitudes reveal key issues; crucially, the Theory of Relatively obfuscates and does not conceive an existence of perfection boundaries.

Light fluids continuum continual flows evolve gravitational field sinks of celestial bodies, all that maintains Black Hole controls of light fluids mass and energy balancing inside boundaries of the galaxy. Black Hole uniquely evolves, lowering or sustaining, mass energy lowest potential level, similar to tropical depression lower barometric pressures forced hurricane eye and strength level, with Black Hole omnidirectional enormous innate energy source of frictionless fluids continuum.

Stars provide most mass energy of said continuum which eventually ends in Black Holes; planets provide a part of said continuum. Based on its size, the Earth uniquely releases mass and energy, because of huge water masses evaporation, stratification, and gradation processes evolved a large atmosphere and since the industrial revolution AGW. Generally, the solar radiations, the Earth's magnetic field and the Earth's relatively weakening gravitational field sink effect magnetosphere retained crucial globose projection size, which is battered by streaming plasma fluids continuum.

The Earth's Advanced Processor dispositions and functions innately spawn light fluids forbidden mechanisms causal effects, Jean's fountain Isotopes and Ions plasma outflow to space. Diatomic air molecular masses, innate interstitial voids similar to gap graded round grains of uniform sand, pass solar and interstellar radiation portions and pass the Earth's irradiations into space; triatomic water vapors and greenhouse gases permeate air masses said voids, similar to liquids permeating into sandy soil, comprising air masses significantly less permeated by radiation; cosmic and solar ultraviolet radiations by impacts split molecules of light fluids, especially water vapors, into ions, causing volume increase energy of distortion and radiations greater heat energy accumulated into the atmosphere and the ionosphere in fluids innate global warming phenomenon; that distends air mass volume boundaries, traps more heat energy, and raises temperatures, and evaporation rates. That spawns forbidden mechanisms, Jean's fountain plasma outflows that locally lower mass and energy volume and temperatures; in asymmetric precipitations, densities of light fluids reposition boundaries, in counteracting Solar and cosmic wind pressures and radiations; to accommodate an innate and anthropogenic global warming (AGW) energy of distortion volume changes, the Earth evaporates, partly decouples, from the Earth's mantle, water and other triatomic and multi atomic greenhouse gases, which decrease diatomic nitrogen and oxygen masses crucial interstitial voids. The atmosphere rising temperatures boosts surficial fluids evaporation rates. Rising water vapor, upon radiations impact in part ionized mass, decouples permanently from the epigene. Energy of distortion and volume changes, stratifications and gradations and evaporations partial decoupling processes enlarge fluid volumes, distend magnetosphere boundaries, and effect plasma fountains. Rises in average global temperatures spawn evaporations and decoupling of plasma. Light fluids mass partial blow-offs, cooling periods conforming to Milankovich cycles with three lower level equal duration periods, effectuate massive emissions of said light fluids every 140 ka. Ubiquitous clusters of the Fluid Elements and said sui generis boundaries induct only attainable remediation.

Ocean tides affirm that celestial bodies deform perimeter boundaries of the Earth's fluids, in that instance by proximities of the Moon's mass gravitational sink. Also, the magnetosphere severely deforms under solar radiations, showering the Moon with subatomic particles as the Moon passes through its magnetotail. Proximity of celestial bodies gravitational sink configurations and Solar light fluids continuum and cosmic pressures and radiations effect enormous immediate dynamics fluxing of light fluid boundaries of the magnetosphere, with continental waters moderate fluxing.

The Earth's magnetosphere embodies a globose inverse offset centric Set fluxing GC forms. In a blow off forcing, fluids energetic continuum dynamics migrate the Set into sidelong Set forms, in genus mutable GC forms; Black Hole mass with energy sink evolves fluids least potential energy level, inducing galactic fluids energy stratifications, gradations and wind pressures and radiations enforced enormous fluxing of the magnetosphere perfect boundaries, which in a blow off spawns suction at the cusp shoulders. All of that imposes the magnetosphere boundaries longevity issue.

Entire magnetic field or its parts can blow off, the Earth's magnetic field extreme reconstructions taking reconstructed magnetic field light fluids energy lowest level; hematite bedrock formations establish magnetic field's repositioning and disposition and date magnetic lines taken orientation.

Evaporation processes expand fluids volume that distends the magnetic lines projection into solar radiations, wind pressures, and Black Hole lowest potential energy predisposed suction; on about 140 ka cycle, a partial blow off cycle, projections of distending and enormously fluxing magnetic lines disconnect, in GC forms transient changing into globose sidelong Set forms, and effecting a mini glacial period reassemble the globose inverse Set forms. The magnetic field lines reconnect and stabilize in return to globose inverse Set forms lowest volumes. Remnants of the atmosphere expand, with drop in temperature, and resurrect the diatomic atmosphere by precipitating most of triatomic vapors. The transient changing about four cycles trigger glacial period. With adequate water reserve, the 140 ka cycles effect harvests continually the Earth's lightly coupled light fluids mass. Average global temperatures rise, causal effect of water resources progressive evaporation and increased vapors quanta in the atmosphere and fluids portion permanent decoupling from the Earth's mass, weakens the electromagnetic field; that leads to a sterility of permanently frozen or overheated planet. Controlled water vapors quanta can sustain strength of the magnetic field and moderate planet temperatures. When Black Hole suction stratification gradation processes partly or lightly couple a Galaxy light fluids that Galaxy entire mass with energy is eventually captured.

The Earth's relatively passive and weak gravitational sink field embodies the ionosphere plasma, fluids which seek lowest potential energy level with no sheer strength and cohesion, dispersed by particles of alike electrical charges and retained by strength of boundaries of magnetic field lines, is battered by streaming continuum of alike plasma fluids. Dynamics of said magnetic field lines and the magnetosphere boundaries embody immediate deformations disposition spawned plasma densities equivalent to those of the streaming continuum or magnetic lines proceed to disconnect. Continuum dynamics on lee side of the cusps spawn suction which magnetic lines must dissipate or magnetic lines disconnect; suction by said dynamics threatens the Earth's light fluids partial or complete blow off. The magnetic field volume least projections and maximal energy are crucial.

The Earth magnetic, gravitational sink fluid mass and energy field cannot entirely decouple from the Universe, Black Hole and the Milky Way Galaxy celestial bodies, gravitational fields of light fluids energy sinks. Said fluid mass energy fields cannot avoid constellation radiations and wind pressures effect. The Earth geology stratigraphic records of solidified fluids mass reveal: magma flows and polar caps and glaciers ground displacements and mantle gradations and stratifications decoupling processes groundwater changes; thus, recorded nearly entire geological and erosional history supplements the Earth fluids innate magnetosphere boundaries revealed a globose inverse offset centric Set, in fluid energy boundaries short period effects, which documents conclusively: a) triatomic vapors, raising globally air temperatures, force Jean's plasma fountains crucial fluids released to space; b) the Earth Advanced Processor spawns electromagnetic field magnetosphere by constituting the ionosphere an enlarged volume, emitting persistently plasma mass and energy to space; c) the Advance Processor inherent mass energy solidifying processes spawn the mantle volcanic activities, tectonic movements, and energy of distortion and volume change greenhouse gases emission; d) the Processor moderates atmospheric temperatures with fluids energy volume.

Quantum concurrent paths tracing the FEIIPMII, PMII mass energy fluids quanta comprises high technologies least energy of distortion of volume change any one of these: the perfect boundaries of the QCNDMEHC, QCMEHC and MEHC flowing fluids and systematic ubiquitously strategic implementation of the Fluid Elements and constituting a clustering of the Fluid Elements said sui generis boundaries constitute the Earth's civilizations survival sole options—the FEIIPMII, PMII technologies quantum energy tracings of light fluids perfect boundaries least release of flowing energy fluids that distend boundaries perfection of the ionosphere and the magnetosphere quanta; quantum energy concurrent PP PPLLS traces Fluid Elements fluid composition functions, the sui generis boundaries, and yields fluids quanta least mass volume maximal function of genus forms; given fluids energy compositions and functions, Fluid Elements MEHC conforming quanta mass then comprises fluids least mass, volume contained highest energy. For listed priority documents and herein, the MEHC flows constitute algorithms computing quantum energy with simultaneous paths of passage (PP) that make PP lengths least sum (PPLLS), wherein upright direction lengths comprise gravitational force multiple. Fluids maximum MEHC comprising minimal PPLLS Sets and least quanta—mathematical complexities forcing functions—reduce to algorithms computing.

The Advanced Processors, QCNDMEHC spawn the boundaries perfection of conforming quanta, fluid densities, and longevity genus genres with least decoupling of energy. The Fluid Elements, the sui generis boundaries, the Sets, GC, globose conduit quanta energy fluids spawn these genus generic Genres: Genre “a”, the GC Sets, the sui generis boundaries as revolutionary technologies true innovations and inventions, light fluids devices; Genre “b”, the paths of passage (PP) lengths least sum, the PPLLS, that comprise algorithms computing of a device, in-situ, forcing functions: fluid compositions least quanta, with fluids energy demand, retaining of boundaries, by quantum energy concurrent PP tracings, determine fluids energy fluids quanta, volume and the sui generis boundaries; Genre “c”, said PAP Line and angle orient, depose and configure a Set disposition of the Inlet, the basin, the outlet and the FESD forms; Genre “d”, the path of passage of least energy demand, the PPLD, constitutes algorithms computing, quantum energy traced, maximally longest tracings path in said PPLLS. The Genres “c” and “d” embody true high technologies computing;

In context of ultimately perfect boundaries, take an atom containing numerous electrons quantum energy paths, tracing a spherical, globose spherical, globose or, an all inclusive, a combination of such forms, as fluxing ranges of atom energy boundary forms. With electrical current that passes quantum energy electrons about the atoms nuclei, the electrons trace globose conduit boundaries; the Genre “a”, generic Genres “a”-“d” is innate to atoms and fluids perfect boundaries Universe.

The atoms, the sui generis boundaries, and the Advanced Processors, as inorganic and the human epidermis, as organic mass energy forms comprise—forms equal functions—external boundaries unique structures that command respective top in evolution chains that interrelate in same genus. A minute electron weight large electric charge spawns atoms entirely round forms; a locality two directional gravity sink spawns out of entirely round the First, Second Fluid Elements perimeter.

Billions of years of said continuum energy demand steady flows continually evolve fluids lowest potential energy sinks evolve the Advanced Processors and Fluid Elements genus, in enormously noteworthy and significant disclosure, revealed said genus and fluids least volume quanta crucial functions and perfect forms. The Universe as fluids enormous hydraulics laboratory, through the Advanced Processors continually evolving light fluids lower potential energy sinks and disclosed said Fluid Elements genus reveal all crucial and necessary facts, data and graphical presentations that yield solutions to sciences three Principal Theories and to water depletions, innate and AGW global air warming, and global energy shortages. Global scientific community and governmental organizations in search for solution on crucial global air warming issues that imperil life on Earth arrived at a consensus to a great degree, by symptoms seen causal effects deeply flawed sciences.

The Advanced Processor and said fundamental Fluid Elements hardly differ. Fluid localities and compositions constitute extreme diversities. But, the Laws of Mass and Energy Conservation for boundaries perfection of fluids are universal. Present in the sciences and missed by humans thru centuries, principles and methodologies of the Fluid Elements reside in revolutionary inventions.

In fluids energy-functions, the fundamental Fluid Elements, draining lines and drain traps, reveal that said gravitational sink and the magnetic field three dimensional presence appears in-situ as if two directional, wherein: a) the MEHC and functions reside in fluids genus genres; b) the PPLLS constitutes algorithm computing forms genres of the conforming least quanta boundaries in Fluid Elements genus for fluids embodied genres and functions; c) the Advanced Processor's magnetic field perfect boundaries shield light fluid, to secure only fluid inducted into a version of the Fluid Elements; d) celestial body weak gravitational field potential energy-sink, the Earth as paradigm, releases available light fluids to universal demand for such mass energy; e) said MEHC versions, genre “a” and “b”, embody processes wherein QCND in fluid compositions of the QCNDMEHC refer to unavoidable fluids innate genres and dissipated energy, wherein said “c” and “d” pertain to fluids core mass energy composition properties, herein the Earth's coupled status fluid genres; f) atmosphere temperatures and pressures constitute part of natural disposition (ND) genres. The Universe mass energy unbalances spawn streaming light fluids energy demands, with Black Hole lower potential energy level. The Fluid Elements sui generis boundaries innovating technologies of nonuniform, nonsteady and nonhomogeneous fluids composition yield the MEHC, QCMEHC and for said fluids molecular frictionless flows, the QCNDMEHC. Deep flaws in the entire prior art contest the Universe perfect boundaries disposition mass energy balances by quantum energy.

Said Advanced Processors, Advanced Fluid Elements, and the Second Fluid Elements yield three dimensional correlations; the correlations of the two are those revealed in the integral calculus, to summarize finite increments cumulative results within range of variables; said fundamental Fluid Elements, said Second Fluid Elements, reveal mainly two of the gravitational sink six directional components. The Advanced Fluid Elements disclose six, two for each of the three directions; the correlations of the QCNDMEHC, QCMEHC and MEHC fluids flow is clear; they are versions of the MEHC. Boundaries perfection correlations among the Advanced Processors and those of the second Fluid Elements are relationships of same genres of said MEHC versions, which force said correlations of perfect boundaries. The Laws of Mass and Energy Conservation affirms that said correlations among the Second Fluid Elements and the Advanced Fluid Elements must hold in all functions, revealing that fluids compositions and the MEHC versions difference becomes crucial in perfect boundaries continual functions. The integral calculus computing methodology reveals the Fluid Elements genus genres, sui generis boundaries three dimensional components traced by quantum mass energy accordant with the Advanced Processors finite to infinitesimal exactitudes, evolved perfect boundaries—the magnetosphere fluxing, said plasma outflows, disconnects of the magnetic field lines, the Coriolis Effect clockwise, counter-clockwise rotation respectively in the plane of the northern, southern hemisphere, with out-of-plane orthogonal component innate three directional motion, large water bodies three dimensional nearly spherical forms free surfaces—all confirm that the correlations comprise exact relationships held to infinitesimal increment details.

The entire prior art treats the gravitational energy sink effect, as a two dimensional and occurring fluids free surfaces as planar, obfuscating epigene correlation with respective the globose domain End 2, globose inverse domain First End and the ionosphere upper boundaries in correlation with free surfaces of the quanta. The geology and astronomy affirm the magnetosphere these failures: twenty wipeouts, at least three changes in magnetic field disposition, the glacial epochs on record and 1500 climate changes of 140 ka periods. Evolving perfection boundaries undeniable affirm—the Advanced Processors participation in the Universe constituted fluids, functions and processes specifically excludes CO2 greenhouse gases as a component of light fluids demand; emitted CO2 gases are only transient global air warming catalysts. With ample precipitations, the epigene can assimilate such gases, in continual steady functioning; said technologies reveal root causal effect of the innate and AGW global warming, groundwater depletion, and energy crisis true solutions. The entire prior art longevity and functions imperfect boundaries emit fluids energy that distends the magnetosphere perfect boundaries with initial directional impetus toward Black Hole suction.

the generic Genres in the Fluid Elements, the MEHC versions reveal the Genres “a”-“d” entirely consistent with atomic elements energy boundaries comprised of electrons, protons and neutrons; the sui generis boundaries, the generic Genre “b”, quantum mass energy tracings effect analogies with electrons traced atomic elements boundaries and quantum mass energy traced the Advanced Processors perfect boundaries and processors and transistors electrical impulses unique solutions processing; the fluids continuum persistently effects versions of perfect boundaries; correlated in genus the Genres “a”-“d” pin the Genre “d”. The Advanced Processors, Fluid Elements, atomic elements traced boundaries by quantum energy conclusively bind everything, spawn said generic Genres in Universe dynamics, and solve the Theory of Uniformity and the Theory of Everything.

Fluid boundaries perfection unifies mass energy from infinities of space to the fundamental Fluid Elements to atomic elements, and mass energy continuum quantum technology correlates perfect boundaries. The FEIIPMII with PMII technologies constitute our civilizations coexistence in the Universe as sole options, made possible by solutions to the Principal Theories, pursued by many.

Said PMII and FEIIPMII fluid technologies spawn inorganic, organic perfect boundaries; the two technologies embody the Theory of Everything sought solution. The application Ser. No. 12/153,036 undeniable analogies correlate genres boundaries and functions of the Earth, the human body, the Fluid Elements, and the Advanced Processors. Here, the solutions to the three Principal Theories include subatomic mass positively bound in the atoms, within the Universe enormous diversities; the solutions embody the Universe; not dividing anything light fluids boundaries perfection binds everything; the Advanced Processors past evolution and diversity embody now-technologies into present paradigms eternity of said Theories united in The Theory of Everything solutions. Fluids bound by evolving boundaries perfection or by a compiling of the FESD forms that constitute the sui generis boundaries said PPPLS absolute lowest sum comprises genome in respective domain.

Subatomic particle—such as “god particle”—cannot possibly resolve the three Principal Theories, due to a key fact—no mass energy evolved boundary exists, for such and any subatomic particle, other than its original bounding by its atom perfect boundaries outside of Black Hole. Subatomic loose mass forces process of stratifications, gradations, and breakdown of the perfect boundaries.

And more key facts, within infinity of the Universe; the domains of subatomic particles comprise potentially infinite number of variables, within infinite number of crucial samples, none of which represent the Universe mass energy entirety—an important fact. Universe fluids and mass energy evolution, through billions of years, continually balance mass energy boundaries of everything or almost everything and eternal evolving omnipresence of said Advanced Fluid Elements. Minutia subatomic split particle lacks definitive boundaries. After billions of years of bound mass energy evolutions that perfected and preserved perfect boundaries, Black Hole forcing stratifications and gradations energy processes show inherently perfect place for such particle, in perfect boundaries bounded everything Black Hole; mass energy defects in ultimate compactions crucial perfections likely spawned Big Bang—none of which is replicable. Construction of FEIIPMII, PMII, and SP devices is truly a matter of survival. Higgs and such subatomic particles as part of atomic energy boundaries are innate to the Advanced Fluid Elements and fluids energy bounding exactitudes of “almost everything”, by correlation of the three Theories. A loose subatomic particle attacks any boundary integrity; universal perfect boundaries existence and solutions solve the three Theories, yielding correlations across domains of fluids functions, irrespective of inner fluid function form.

Universally the perfect boundaries comprise the Universe mass and energy from atomic elements to Black Holes, wherein the Earth's magnetosphere magnetic field lines comprise paradigm of in situ—functions equal forms—forcing dispositions instantly taken by the perfect boundaries. Said dispositions stressed, under disposition forcing functions, transfer and transpose forms Set within fluxing of boundaries perfection. The Earth's Advanced Processor superimposing magnetic field and fluids mass and energy evolving of low potential gravitational sink significantly benefit with coordination of said FEIIPMII, PMII and SP. Streaming cosmic radiations wind pressure energy dynamics, plasmas flowing energy continuum densities impact the Earth's magnetic field perfect boundaries, wherein plasma densities on both sides of the boundary configuration dispositions by fluxing and in repositioning of boundaries complete complements balance boundaries perfection. In domain, fundamental Fluid Elements complete complements perfect boundaries transpose and traverse basin outlet forms of GC parent into Sets, which the application Ser. No. 09/850,927 depicts and details and illustrates for in-situ inflow. Inlets and outflow outlets disposition effecting Set forms; above enormously powerful revelations yield that Universe mass energy imbalances are balanced by light fluids gravitational field sinks evolving a potential energy lowest level, which effects the respective magnetic fields fluxing, evolving, and delineating of perfect boundaries that, if forced, traverse the magnetic field forms Set across fluids energy domains of that Set, into lowest energy disposition perfection conforming to exactitudes of quantum mass energy. In said lowest, excess fluids mass energy, including erratic subatomic particles, constituted MEHC directional paths are dumped at perfect boundaries, and if not stuck-in, amalgamated into Black Hole. Said Advanced Fluid Elements, planets mass energy, innate functions with superimposed fluxing magnetic fields perfect boundaries mass low level energy lowest potential sink takes weak gravitational field that streaming plasma fluids energy demands of Black Hole configure, by capturing errant, loose, and lavish light fluids energy. Commanding presence of Black Holes gravitational mass energy sinks captures Stars respective streaming fluids energy fields, also. Black Holes of Galaxies spawn the Universe function, processes constant highly delicate balance continual search for configurations of entire mass energy into a lowest potential energy sink, one enormous body, by fluids mass and energy forcing demand; mass energy combat extends through endless processes of stratifications, gradations, unifications and configurations. Universe unbalances effect Black Holes unifications to one space time location, with dynamics that preclude a break up. One Black Hole Universe, in one body warped space time is not impossible. But that effects generic reconstructions of perfect boundaries in the Universe and the Earth's magnetic field dispositions retained light fluids lavish atmosphere and ionosphere a prime target; the Fluid Elements and their innovations clustering of revolutionary technologies, in ubiquitous implementation, must spawn the magnetic field volume boundaries crucial integrity, as fluids partial decoupling which does distend the boundaries of the magnetosphere into streaming solar, cosmic continuum, imperils survivals of life forms on Earth.

Black Hole suction seeks light ions mass energy and attacks light elements innate boundaries that block light plasma ions energy linear transports; the Universe quenchless insatiable mass energy imbalances, in unrestricted eternal persistence to attain perfect balances, configure the Advanced Processors light fluids perfect boundaries in processes that evolve celestial bodies; the Jean's plasma fountains balancing of boundaries relieves temporarily light fluids pressure enlarged volumes causal effects, the corrected Shell Theory light fluids global warming term, with AGW only a symptomatic and transient participant. That is sciences reality; undeniable geologic history by irrefutable evidence reveals the Earth's enormous water mass loss, from a time period it was entirely ice covered, which bares real threat to highly egoistic civilizations.

The Earth, the Sun, and the Milky Way galaxy, effecting near apsis, orbited Black Hole about 20 times. Space craft Cassini irrevocable evidence video shows light fluids mass migration to fluids lower potential energy gravitational sinks. In throes of Black Hole periapsis, the Earth, and thus, the planets in the Solar System lost light fluids, including wipeouts of respective magnetic fields. Fluids ice mass coupled optimally to crusts of planets stayed coupled, to subsequently regenerate reconstruct magnetic fields; after each magnetic field wipeout, the Earth experienced enormously long glaciation periods, at least three magnetic field disposition changes, hematite bedrock layers revealed and in all over 1500 climate changes, at each 120-140 ka interval. That makes the IPCC recommended AGW CO2 emissions control irrelevant, as a forcing effect long term valid option.

Black Holes' streaming mass energy demands, MEHC, and magnetic and gravitational fields rule the Universe with densest mass energy densities dominating at confronting perimeter boundaries; minima and maxima gravitational force sinks, conforming least mass functions MEHC, spawned—forms equal functions—functions equal forms genres—evolve globose, spherical celestial bodies. Said fountains light fluids plasma outflows, thru the magnetic field cusps, pay with highly valued commodities—nitrogen and water based ions that constitute outflows plasma; strongest magnetic field, and gravity sink, least volume ionosphere densest light fluids boundaries are a forced must.

Light fluids Universe, Galaxies, Black Holes, celestial bodies, Fluid Elements, Isotopes and Ions mass energy functions, and the Shell Theory made whole solves the Theory of Uniformity riddle. Limit of science overcome by the Shell Theory made whole solves the Theory of Uniformity that reveals Earth Advanced Fluid Element functions and validates the magnetosphere forced volume narrow range variations forced by Solar, cosmic radiations, wind pressures, and Black Hole mass energy demand streaming plasma low potential energy level, which force magnetic field failures.

Milankovich cycles reveal that every 100-140 ka triggers a climate change, following a partial or a complete blow-off of the Earth's magnetic field and parts or entire atmosphere, which attests to the importance of fluids, especially water phases status stated coupling to the Earth's mass; listed reference, GC Boundaries, U.S. Ser. No. 12/153,036, undisputed geological histories of hematite bedrock layers recorded magnetic field shifts, the epigene erosional features revealed retreating glaciers history of ground surface moraines, and astronomical observations of adjacent planets compiles overwhelming evidence—Fluid Element Advanced Processor, the Earth, delicate balance is taxed for the ecosystem in the galaxy with plasma fountains venting periodic outflows. After a blow-off magnetic field lines reconnect, resurrecting the magnetic field, with atmospheric volume modest expansions which cool the atmosphere, spawn enormous precipitations and force multi atomic molecules out of the atmosphere, constituting a highly diatomic highly porous fluid; that process drops the atmospheric air temperatures and allows higher portion of Sun's radiations and the Earth irradiations to pass through, causing a glacial period. Subsequently spawned water vapors energy reheats light fluids mass, distends its boundaries, and restarts plasma outflows; the magnetic field and magnetosphere strengths and high density plasma preserved gravitational sink effects constitute only means that oppose forcing suction of plasma at cusps shoulder and suction tendency to pull high altitude jet streams into higher latitudes thru effectuated periodic blow offs.

Undeniably, the epigene and atmospheric temperatures interrelate; in interglacial period, the land temperatures rise with rise in atmospheric temperatures, even if the Earth's mantle along with the atmosphere continue in a geological long term cooling process. In fact, such is the case, revealed by undeniable evidenced of continual water based ions and light plasma outflows into space. For temperatures historic trends, interglacial and glacial period real temperatures data is a must. That true data does not exist; interglacial, glacial periods expectedly raise, drop respective CO2 levels; the epigene and atmospheric temperatures must correlate consistent trends, provided fluid vapors precipitate with constitutive consistency; none of which is the case. CO2 gases cyclical trending, thru geologic time, constitutes symptomatic rather than causal effects. Ice sublimation and water evaporation move upwardly water vapors quanta and portion of multi atomic gases present in the atmosphere. With portion of light fluids periodic decoupling from the Earth fluids, heavier gases concentration in the atmosphere increases, including CO2 levels. The CO2 levels must continue rising until quanta of precipitation rates exceeds that of the sublimation and evaporation rates for a sustained period and until precipitation of CO2 quanta exceeds CO2 innately generated quanta.

That happens at a glacial period start; the Earth possibly ½ ways thru a ¼ of 140 ka cycle will see CO2 levels rise for many millenniums; CO2 emission cuts cannot yield results. For that, the cuts must exceed AGW; the boundaries perfection ubiquitous, prompt implementations are a must do.

Within 0.02 ka, historically steady functional trends of the Earth Advanced Processor epigene can eradicate all fossil fuels CO2 peak level emissions and compensate for imposed effects; however, said trends compensate for all emissions from the epigene, by crucial light fluid plasma outflows. As accumulated byproducts mass, AGW CO2 levels especially peak levels, reveals a presence of overriding forcing functions; said levels as reactionary effect cannot predict the forcing functions trending. Solving said Theories reveals that plasma sources embody forcing functions key trends and reversals. The IPCC cuts in AGW, CO2 emissions are inconsequential effects to Black Hole light fluids mass energy demand destructive outreach for ions by corrosion, evaporation, friction, combustion, buoyancy, ionization, erosion and alike, gradations and stratifications processes that eventually overcome ultimately perfect boundaries of continually evolving Advanced Processors.

The revelations of the Fluid Elements, Isotopes, and Ions principles methodology, inventions and innovations (FEIIPMII) effect a version of perfect boundaries longest longevities, with sustained fluids energy maximal functions, retain fluids energy functions maximally sealed boundaries and spawn energy least transfers into the atmosphere by fluids maximal coupling to the Earth's crust.

Disclosed root causal effects, solutions, and inventions leave no doubt—they are facts indeed. Carbon dioxide molecular weight and its resistance to break into ions force CO2 return to the epigene, unless continual forcing of the atmosphere endlessly replaces that CO2 mass energy, disclosing transiency of CO2. Water vapors partial decoupling processes enlarge fluids mass volume and accelerate vapors recycling rates, effect precipitations and forbidden mechanisms spawning of ionized fluids innate potential to entirely decouple from the Earth's mass. These processes enormous momentum can accelerate out of control and trigger blow-off effects that collapse the ionosphere mass volume. When light fluids enter into stratifications, gradations processes, only release paths spawn the plasma outflows from the Earth's magnetic field and gravitational sink, risking the magnetosphere status and magnetic field light fluids blow-offs.

The SP reverse causal effects of innate global warming, AGW and water depletion processes, by shunting water vapors heat transfers to groundwater in energy generation unique function.

The priority data and here sciences, methodologies, technologies, innovations and inventions expose the prior art deeply flawed fluid mechanics obsolete technologies, methodologies, and devices; unless extraordinarily swift and comprehensive global corrective measures take root, this civilization suffering harshly through millennia may eventually become extinct. Herein, stated revelations and correction with solutions to sciences three Theories change everything.

Said Fluid Elements with their clustering oppose the Earth light fluids said decoupling processes, gradations and stratifications—effects that distend the magnetic field lines and the magnetosphere boundaries, force globally innate air warming and AGW, sap the magnetic field and gravitational sink vital strengths, impel the Earth toward a sterile-dry plant status, and imperil this civilization. Mass energy light fluids innate shield of Celestial bodies, evolving perfect boundaries, reveal the sui generis boundaries, also; the FEIIPMII, PMII, and SP devices and revolutionary technologies advancement embody means for opposing Black Hole suction forcing perfect boundaries breach. Said PMII and SP sui generis boundaries and the FEIIPMII fluid boundaries perfection minimize water vapor decoupling; the SP aqueducts heat transfers remove excess triatomic gaseous masses from the atmosphere; the SP power generation least AGW for innately diatomic atmosphere least volume changes effects climate control. Said aqueducts added irrigation functions transfer water vapor into enlarging ultimately secured groundwater, water reserve that is entirely coupled to the Earth's crust. Heat transfers into epigene expansions by benign energy of distortion with volume changes hinder volcanic and tectonic events and innately contain the Earth's least coupled fluids.

The Advanced Processor shielded magnetic field fluids quanta, vapor precipitation functions and the SP maximally coupled hot fluids in Fluid Elements clustering for outflow into buried thermal aqueducts positively transfer and dissipate heat energy into the epigene mass and energy ultimate heat sink. Thus, fluids thermal energy taken from the magnetic field fluids quanta and dissipated into the epigene reverses fluid vapors distention of the magnetosphere boundaries and constitutes means of epigene irrigations enlarged groundwater boundaries of ultimately coupled fluids to the Earth's mass, with crustal boundary that retains most of internal electrical and heat energy. Fluid processes sustained in the Fluid Elements and their radial and series clusters in said SP, including subgrade slurry walls, constitute fluid boundaries longevity. Precipitations heat energy coupling to groundwater, in the epigene light fluids heat energy transfer, by the SP electrical power output processes avoids forbidden mechanisms, with epigene boundaries innate resistance to light fluids energy partial decoupling, as the epigene innately retains electrical and thermal energy; en masse ubiquitous Fluid Elements and their clusters, FEIIPMII with PMII devices, carry our civilizations global energy demand options, in-part return light fluids mass energy to the epigene and confront innate and anthropogenic global warming and universally forcing demands for light fluid energy.

Triatomic emissions return to prior emissions level that discards water vapors effect, permit short term goals, but lead into eventual unmitigated failure. The Mars epigene absent of flowing fluids shows fluvial features massive erosion. Fluids that the Sun can evaporate and blow off, at such a distance, are water ions; the surface of Mars is rocky, dust covered mostly dry frozen and under a carbon dioxide atmosphere; Venus atmosphere several billion years ago was more like that of the Earth, now with no water, comprises mainly carbon dioxide extremely thick gaseous atmosphere, remnant left behind. The Earth's magnetic field magnetosphere constituting boundary layers, the ionosphere grading of plasmas, protect water vapors from solar and cosmic winds and radiations. Black Hole suction omnidirectional processes impose irreversible sterility; magnetic field perfect boundaries and processes comprise key genres that innately retain fluids and vapors mass energy. Geothermal power electrical generation accelerates the epigene long term cooling, devitalizes the magnetic field function, effects energy of distortion and volume changes deep in the epigene, and invites potential tectonic movement and volcanic activity energy fluids enormous release into the atmosphere. All of that lowers the Earth's innate roadblocks to light fluids decoupling processes.

Ubiquitous wind turbines dam up air circulations, and the turbine blades mix diatomic air and other molecular structures; all that lowers diatomic air porosity, permeability and retains heat energy greater portion in the atmosphere, and thus, compels water vapors rising to yet greater altitudes, along with heavier molecular structures, such as CO2. Thus raised air temperatures create even more water vapors, which further heats air masses. That postpones condensation and precipitation of water vapors; and, when precipitation does occur, it comes down in huge quantities that in gushers inundate the epigene large flood plain entire watershed, to gush thru rivers of the flood plain to tropical belt climate. All of that optimizes water vapor permeating the atmosphere and light fluids loop cycling frequencies thru the epigene and the atmosphere, effectuating light fluids more frequent splitting into ions and forcing of said plasma outflows.

AGW, CO2 emissions portion replaced by wind power electrical generation reduces CO2 gas portion which is a very small fraction of the CO2 innate emissions and yet smaller fraction of greenhouse gases complex in the atmosphere; ubiquitous utilization of wind turbines dams up air circulation and delays precipitation of vapors, including a portion of the greenhouse gases complex in the circulation. That in turn raises air temperatures and surface water evaporation rates. Thus, wind turbines clean energy generation amplifies effects of greenhouse gases; said evaporation rates innately generate more of most potent greenhouse gas, water vapors, which can accelerate out of control, offset benefits of reduced CO2 emissions and trigger blow-offs.

In addition to wind turbines and fossil fuels generated energy that distend the atmosphere and ionosphere boundaries, solar devices bar solar energy from reaching the epigene crust, which takes energy from said magnetic field and the magnetosphere ultimately disposed boundaries. Land based solar bulk electrical generation accelerates the Earth's cooling and magnetic field subtle deterioration; both are detrimental and irreversible and may spawn the Earth wobbling. Prior applications described electrical power generations with in situ solar panels over waters and transportation devices applied in the art associated technologies are temporarily deferred.

Of all devices that generate energy, the SP comprise the only devices that offer this civilization a survival chance, with said Fluid Elements as only longevity devices that avoid energy emissions. Revealed MEHC versions fluid mechanics high technologies embody true revolutionary devices.

Supra correlate the Advanced Processors, the fundamental Fluid Elements boundaries, and of the atoms excluding said suction, since minute mass electrons energy flowing cannot spawn suction. In the Theory of Everything, solutions context comparative analogies among the Advanced Fluid Elements in fluids perfect boundaries genus show presence of evolving GC Set forms as building mechanisms that unify the Universe. Extensions of magnetosphere boundaries and extensions of human epidermis and limbs effect complete complements of embodied genus genres of forms, by fluxing boundaries perfection which in functions comparative analogies holds true irrespective of internal forms. In said comparative analogies, which analyze functions crucial issues, the human nervous system relates to the magnetic field lines; most of the cardiovascular system corresponds to the magnetosphere bounded fluids systems, the epidermis internal organs constituted functions corresponding to the epigene functions. In said Theory of Everything comparative analogies, the epigene, the renal system, suffers from chronic, at times, severe and discomposing malfunctions, revealed in stratigraphic geology records that chart undeniable evidence of the epigene mass and energy light liquids greatly depleted reserves. In said comparisons, the root and causal effects of temperature rises in the magnetosphere bounded light fluids arise from the epigene innate, severe malfunctioning—“renal system” severe malfunctioning aggravated by not insignificant quantities in the atmosphere of greenhouse gases AGW component; the renal malfunction only remediation is timely dialysis procedure. Said Second Fluid Elements comprise the fluid quanta least volume limit that embodies a fluid portion as a margin of additional fluid needed for reliable functioning; the polar ice caps most likely constitute water phase margins of light fluids that secure livelihood of the Earth's fauna and flora—scientific communities certainly seem to think that that is the case.

Note quantum energy phenomenon similarities of Sets domain functional transfer in FIG. 18 cells and the magnetic field cusps, wherein MEHC fluid dynamics spawn fluids suction similar issues. Also, globose inverse domain Sets are prone to suction and Sidelong Sets cause the flowing fluid energetic angular momentum that requires fluid volume safety margin, as the subsequent explain. The Earth's magnetic field in transient transformation modulates—among globose inverse Set and Sidelong Set configurations. In unpredictable chains of forbidden mechanisms, a Jean's fountain minuscule outflow can end in a partial or a complete blow-off of the ionosphere, the atmosphere.

We need positive result now. In said analogy, the PMII, FEIIPMII, and SP devices transport and transfer light fluids mass energy, yield individually, jointly crucial solutions of said Theories that delineate our civilizations survival highly limited options and comprise critical corrective actions that also embody key time window for the devices ubiquitous global functioning to attain results.

Within the Theory of Everything analogies, the magnetosphere and the human epidermis perfect boundaries embody complex fluids energy functions in inorganic, organic domains, respectively; wherein, in comparative crucial functions, said two Advanced Fluid Elements embody respective chronic internally evolved malfunctioning causal effects that innately degrade crucial boundaries critical functions, threaten full life expectancies of both, allow crucial fluids similar remediation, force remediation effects crucial deadlines and reveal the two in consistent, stunning correlation. Most significantly, continental groundwater levels sullen lowering is drying up the epigene when the polar caps are melting. The epigene ails from irreversible 5 billion years continual processes that decoupled enormous mass of its pure water; forced AGW CO2 emissions 500 years duration is not insignificant water mass unavoidable, additional decoupling. Scientific communities focus on climate change is really incorrect only to the extent that the root causal effects reside in sullen dry up of the continents and the Jean's fountains light plasmas decoupling from the Earth's mass.

Notably, the prior art nuclear plants suffer from efficiency of about 35% and in overall functions emit water vapors huge amounts. Supra makes amply clear—the SP electric power is sole option. Universally stunning uniformity in omnipresent demands for light fluids energy, from infinity of space to infinitesimal detail, discloses the fundamental Fluid Elements, the solutions to the Three Principal Theories and the civilizations survival highly limited options solitarily course of action. The organic domain fauna and flora, from protozoa to humans, in stunning continual consistency migrate to, crowd around, and compete, in growing agitations and confrontations, for the epigene shrinking water sources. Mandated AGW emission cuts will not effectively conserve water; said sui generis boundaries and devices full potential timely ubiquities preclude a doomsday scenario.

### BRIEF DESCRIPTION OF THE DRAWINGS

Principles of inventions that the specifications document and disclose and the drawings illustrate are not limited to the illustrated examples. Having a drawing, one could make modifications and vary figures of the same and not depart from scope of the inventions, disclosed by the inventions.

The principles with technologies of the inventions are susceptible to variations; the specifications specify and the drawings illustrate number of the Sets only as paradigms of the Fluid Elements of genus; the fundamental, the First and the Second Fluid Elements, also are referred to as said Sets.

The Universe, galaxies, celestial bodies and Black Hole functions reveal means for energy crisis, water conservations and innate geophysical and anthropogenic global air warming real solutions.

Herein, sciences explain light fluids energy evolved bodies—functions equal forms, forms equal functions—science energy conservation processes that rule the Universe and yield said solutions.

Revealed and claimed light fluids perfect boundaries, exemplified by the Earth's magnetosphere, constitute our civilization only survival options solve the Shell Theory, the Theory of Uniformity and the Theory of Everything, and reveal true and revolutionary genres of the perfect boundaries.

Innate processes and the MEHC versions of the PMII and FEIIPMII correlate details of the Fluid Elements genus functions innate versions of ubiquitous perfect boundaries, herein illustrated, the First, the Second fundamental Fluid Elements, fluid mechanics true high technologies sui generis boundaries, said Sets in the prior art as draining lines and drain trap functions respective devices.

The sui generis boundaries in everything genus of the Advanced Processor apply to clustering of the Fluid devices in most crucial functions such as those of nuclear power plants, the SP devices.

The magnetosphere fluxing boundaries and magnetic lines forcing disconnections, reconnections as profusely described and illustrated—in the literature, on the Internet—need no illustration here.

FIG. 1 schematic of genus Second Fluid Elements parent is shown as comprising cross-sectional view of globose domain generally taken about upright plane of symmetry of genus parent of said GC and the Second Fluid Elements and also of organic domains single cells shown with no Inlet. General ubiquity of the parent in inorganic and organic domains various versions supra describe. FIG. 1A of the drawings shows a globose genus Second Fluid Element invention schematic of a cross-sectional view taken generally through a PAP Line and upright plane of symmetry;

FIG. 1B of the drawings shows schematic of the prior art simple trap cross-sectional view taken generally about upright plane of symmetry;

FIG. 2 of the drawings shows a globose sidelong Second Fluid Element invention cross-sectional view generally taken thru a PAP Line, upright plane symmetry and these FESD forms, inventions: a rounded End 2, a PPLD band with a rounded lowest form a discharge cross-section surface (DCSS) forms;

FIG. 3 of the drawings shows FIG. 2 invention sectional top view taken generally about Line A-A;

FIG. 4 of the drawings shows a globose circumferential sidelong Second Fluid Element invention cross-sectional view taken generally thru PAP Line upright plane of symmetry and these FESD forms, inventions: a Trough, an Infant-Boot End 2, a PPLD band with a rounded lowest form, a Fin, and a discharge cross-section surface (DCSS), and a Flush Apparatus assembly invention;

FIG. 5 of the drawings shows a Ridge FESD invention cross-sectional view taken generally about Line C-C of FIG. 4 invention;

FIG. 6 of the drawings shows a Trough FESD invention cross-sectional view taken generally about Line C-C of FIG. 4 invention;

FIG. 7 of the drawings shows a globose centric Second Fluid Element invention cross-sectional view taken generally thru a PAP Line, upright plane of symmetry, and these FESD forms, inventions: an Infant Boot End 2, an Inlet conical centric form, a PPLD band with an annular valley form, a Bridging Wall, and a DCSS and a Flush Apparatus assembly invention;

FIG. 8 of the drawings shows a cross-sectional view of a Bridging Wall FESD invention taken generally about Line CCC-CCC of FIG. 7 invention;

FIG. 9 of the drawings shows a cross-sectional view of a Bridging Wall FESD invention taken generally about Line C-C of FIG. 7 invention;

FIG. 10 of the drawings shows a cross-sectional view of a Bridging Wall FESD invention taken generally about Line CC-CC of FIG. 7 invention;

FIG. 11 of the drawings shows a globose centric Second Fluid Element invention cross-sectional view taken generally through a PAP Line, upright plane of symmetry and these FESD forms, inventions: an Infant Boot End 2, an Inlet conical offset form, a PPLD band with a crescent form, a Bridging Wall, and a DCSS and a Flush Apparatus assembly invention;

FIG. 12 of the drawings shows a globose cylindrical, offset centric Second Fluid Element invention cross-sectional view taken generally thru a PAP Line, upright plane of symmetry and these FESD forms, inventions: a Trough in a Trough, Inlet Flared End 2, an Inlet conical centric form, a PPLD band an annular valley form, a DCSS and a Flush Apparatus assembly invention;

FIG. 13 of the drawings shows a sectional top view taken generally about Line C-C of FIG. 12 invention;

FIG. 14 of the drawings shows a globose cylindrical centric Second Fluid Element invention cross-sectional view taken generally thru a PAP Line, upright plane of symmetry, and these FESD forms, inventions: a rounded End 2, an Inlet conical centric form, a PPLD band with an annular valley, an elliptical upright major axis outlet First End, and a DCSS;

FIG. 15 of the drawings shows a globose inverse cylindrical centric Second Fluid Element invention cross-sectional view taken generally thru a PAP Line, upright plane of symmetry, and these FESD forms, inventions: a rounded First End, a First End conical centric form, a PPLD band with an annular valley form, and a DCSS;

FIG. 16 of the drawings shows a top view of a globose centric Inline Second Fluid Element invention of the FIG. 17 invention;

FIG. 17 of the drawings shows a globose centric Inline Second Fluid Element invention cross-sectional view taken generally through a PAP Line, upright plane of symmetry, and these FESD forms, inventions: an Inlet about an inner Inlet with a flared rounded End 2, a PPLD band with an annular valley, a Partition, and a DCSS;

FIG. 18 of the drawings shows a Partition FESD form of a globose centric cylindrical Inline Second Fluid Element invention cross-sectional view taken generally about an upright plane orthogonal to the FIG. 17 shown cross-sectional view;

FIG. 19 of the drawings shows a globose angled anti-sidelong Second Fluid Element invention cross-sectional view taken generally thru a PAP Line, upright plane of symmetry and these FESD forms, inventions: a curved Inlet End 2 with a counterpart basin filler member, a PPLD band with a rounded lowest form, and a DCSS and a Flush Apparatus assembly invention;

FIG. 20 shows a globose angled anti-sidelong Second Fluid Element invention cross-sectional view taken generally thru a PAP Line, upright plane of symmetry, and these FESD forms, inventions: a curved Inlet End 2 with a counterpart basin filler member, a PPLD band with a crescent form, and a DCSS and a Flush Apparatus assembly invention;

FIG. 21 of the drawings shows a globose inverse angled centric Second Fluid Element invention cross-sectional view taken generally thru a PAP Line, upright plane of symmetry and these FESD forms, inventions: a First End with a counterpart basin filler member, a PPLD band with a rounded lowest form, and a DCSS and a Flush Apparatus assembly invention;

FIG. 22 of the drawings shows a globose inverse angled sidelong Second Fluid Element invention cross-sectional view taken generally thru a PAP Line, upright plane of symmetry and these FESD forms, inventions: a First End with a counterpart basin filler member, a PPLD band with an annular valley form, and a DCSS and a Flush Apparatus assembly invention;

FIG. 23 of the drawings shows a globose inverse low angled sidelong Second Fluid Element invention cross-sectional elevation view taken thru a PAP Line, upright plane of symmetry and these FESD forms, inventions: anti sidelong Inlet End 1, a First End, a basin filler member, a PPLD band a rounded lowest form, a DCSS and a Flush Apparatus assembly invention;

FIG. 24 of the drawings shows a globose low angled centric Second Fluid Element invention cross-sectional view taken generally thru a PAP Line, upright plane of symmetry and these FESD forms, inventions: an anti sidelong Inlet End 1, a First End with a counterpart basin filler member, a PPLD rounded lost form, and a DCSS and a Flush Apparatus assembly invention;

FIG. 25 of the drawings shows a globose circumferential hybrid dual sidelong Second Fluid Element invention cross-sectional view taken generally thru a PAP Line, upright plane of symmetry and these FESD forms, inventions: a Fin End 2, a Fin, a Fin Partition, and a DCSS and a Flush Apparatus assembly invention;

FIG. 26 of the drawings shows a sectional view of a Partition FESD form invention, taken about Line C-C of FIG. 25 invention;

FIG. 27 of the drawings shows a cross-sectional view a First Fluid Element invention of conduit forms genome and genus parent, for nonhomogeneous, nonuniform, and nonsteady fluids flow;

FIG. 28 of the drawings shows a sectional view generally taken through a circumferential basin outlet of a circumferential strain genus Second Fluid Element invention;

FIG. 29-31 of the drawings shows a cross-sectional view taken generally through respective PAP Lines and upright planes of symmetry of the three said globose centric Second Fluid Elements, showing versions of Flush Apparatus invention networks, assemblies, and parts; and

FIG. 32 of the drawings shows a cross-sectional view of a globose cylindrical centric Industrial Second Fluid Element invention taken thru a PAP Line, upright plane of symmetry and these FESD forms, inventions: a rounded End 2, three Sub-outlets FESD forms, a DCSS, a Holding chamber, and a Flush Apparatus assembly invention.

### DETAILED DESCRIPTION OF THE DRAWINGS

Principles of inventions that the specifications document and disclose and the drawings illustrate are not limited to the illustrated examples. Having a drawing, one could make modifications and vary figures of the same and not depart from scope of the inventions, disclosed by the inventions;

The principles with technologies of the inventions are susceptible to variations; the specifications specify and the drawings illustrate number of the Sets only as paradigms of the Fluid Elements of genus; the fundamental, the First and the Second Fluid Elements, also are referred to as said Sets.

The Universe, galaxies, celestial bodies and Black Hole functions reveal means for energy crisis, water conservations and innate geophysical and anthropogenic global air warming real solutions. Herein, sciences explain light fluids energy evolved bodies—functions equal forms, forms equal functions—science energy conservation processes that rule the Universe and yield said solutions.

Revealed and claimed light fluids perfect boundaries, exemplified by the Earth's magnetosphere, constitute our civilization only survival options solve the Shell Theory, the Theory of Uniformity and the Theory of Everything, and reveal true and revolutionary genres of the perfect boundaries.

Innate processes and the MEHC versions of the PMII and FEIIPMII correlate details of the Fluid Elements genus functions innate versions of ubiquitous perfect boundaries, herein illustrated, the First, the Second fundamental Fluid Elements, fluid mechanics true high technologies sui generis boundaries, said Sets in the prior art as draining lines and drain trap functions respective devices.

The PMII disclose the fluid boundaries perfection and the sui generis boundaries universal genus genres in the Advanced Processor in the fundamental Fluid Elements and in the atomic elements. The genus genres, in clustering of the Fluid Elements, open up entire field of crucial innovations.

The sui generis boundaries in everything genus of the Advanced Processor apply to clustering of the Fluid devices in most crucial functions such as those of nuclear power plants, the SP devices.

The magnetosphere fluxing boundaries and magnetic lines forcing disconnections, reconnections as profusely described and illustrated—in the literature, on the Internet—need no illustration here.

The Advanced Processor, the magnetic field perfection boundaries shield fluids quanta functions embodied said FEIIPMII universal GC Sets, stratifications and gradations forbidden mechanisms processes, which spawn said decoupling processes, are better understood with descriptions of the fundamental Fluid Elements, inventions, wherein: a) said Advanced Processor perfect boundaries embody the Earth fluids mass gravitational sink and magnetosphere processes innate forms equal functions or vice versa and illustrated b) inventions of the First and Second Fluid Elements, Sets. The Second Fluid Elements said sui generis boundaries embody a discharge cross-section surface (DCSS), outlet forms, and First Fluid Elements cross-sections—paradigms that FIG. 27 illustrates.

The First Fluid Elements said sui generis boundaries genres spawn the transition region with said PAP Line and PPLD band nearly paralleling, wherein low angled Sets, FIG. 23-FIG. 24, comprise the PAP Line, PPLD band genres least separation, fluids energy highest utilization, in the Second Fluid Elements domain. Genres of GC breadths of the lower conduit, transition region and upper globose cross-sections raise high density fluids PP, lower low density fluids PP and embody Inlet and basin outlet in-situ dispositions respective orientations and conforming fluids least quanta for the sui generis boundaries fluid quanta: least volume limit and a short height, short length surface areas smallest sum free surfaces area maximal sum and hydrostatic light pressures, in completely matching complete complements globose-conduit (GC) forms, at highest elevations, inducing the Sets longest longevity structures; the PAP Line angles reveal energy genres of fluids quanta flux demand for light fluids energy which avoids slow clogging and light fluids wastage. Said quanta genres affirm fluids perfect boundaries and sui generis boundaries of the Fluid Elements devices; said MEHC yield—forms equal function, functions equal forms—said domains and Sets governed by said Laws in mechanics of forms configuration of the Sets to finite, nearly infinitesimal detail.

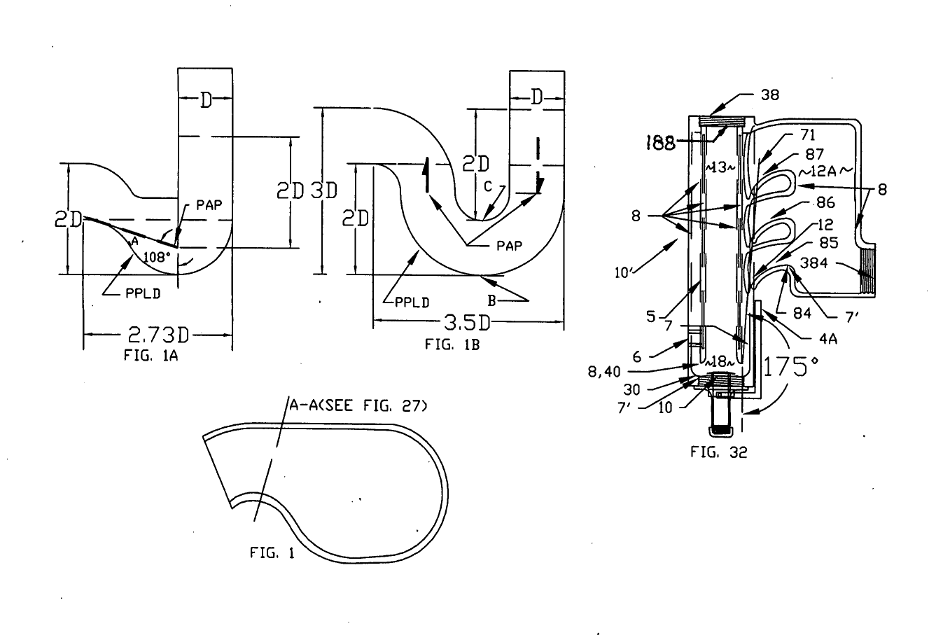

The entire prior art residents embody en masse failing technology functions comprising a domain of deeply flawed mechanisms technology designs; a simple trap epitomizes longevity of the prior which dwells in failures domain; FIG. 1A and FIG. 1B compares FIG. 1A structure with FIG. 1B as the best of simple traps. Said simple trap computed genres show: a) 2.5 times greater fluids mass retention; b) 5 times greater fluids mass interface surface perimeters; c) at least 2.25 times higher operating pressure; d) for one retained fluid quanta turnover at least 2 times energy lift and outlet forcing large back pressures; e) friction at least 11.25 times greater—b times c; f) at least 5 times more energy required, said c times d (many times greater for GC Set comprising an outlet FESD, herewith, described); g) large angles form directional changes, resulting in 3-90° bends, forming bending moments structural Z-properties, stresses concentration—FIG. 1B noted, Points B and C.

A simple trap PPLD is more than twice as long, twice as deep and long enough to cause retention quanta reversing directions induced lost energy, by pulsing outflows latent responses disharmony with fluxing fluid inflows; and a discontinuous PAP Line incomplete PAP angle of 180° or more. FIG. 1B reveals said trap a digestive tract trait, whereas FIG. 1A structure showcases conduit traits.

FIG. 1A shown structure embodies a PAP Line short length comprising angle of 108°, the PPLD band a short length the outlet embodied FESD forms for light back pressure, and long longevity. FIG. 1A has exponentially lower fluids demanded energy and embodies preferred hoop stresses.

Homogeneous, nonhomogeneous and nonuniform nonsteady fluid flows configure said Sets from genus parent whose schematic cross-sectional view thru PAP Line upright plane symmetry FIG. 1 shows; the parent boundaries comprise fluids in-situ Inlet and outlet matches and ample potential energy—not shown—an open mouth or least height inflowing Inlet, consistent with PPLD band of parent and genres associated rotations and orientations in configurations that constitute said Sets.

The drawings disclose Sets and forms which are determinant, to finite elements resolution, which constitutes enormously more precise structures than those of the prior art. Said MEHC and least energy of distortion effect relationships, inducing said sui generis boundaries respective structure stresses and strains multiples least sum: Sets and forms maximal longevity genres and structures.

Genus parent forms rotate, mutate, transpose and transfer into said Sets and hybrids said domains of globose strain as graphically illustrated and described in application Ser. No. 09/850,927; retention fluid, the fluid quanta, resting and rotated in horizontal plane about upright axis of entirely round fluid form, such as entirely round Inlet axis and fluid form, sustaining entirely round its retention fluid free surface form reveals an upright Set and said form change indicates an angled Set. Said undersurface disposition and the Sets associated genres distinguish domain and the Sets, wherein the undersurface migration specific disposition, from a basin-outlet blind side to an anti-sidelong disposition that is opposite to the basin-outlet blind side, identifies a Sidelong, a Sidelong Offset, an Offset Centric, a Centric, an Anti Offset Centric, an Anti Sidelong Offset, or an Anti Sidelong Set in said domains, including the Industrial and the Inline Sets which readily mutate and migrate embodied forms in respect to the basin. A disposition of the End 1 also in respect to the basin, in similar characterization, further distinguishes the Sets, along with overall appearance—a globose or a cylindrical shape. Overall angularities—upright, angled near upright, angled—distinguish the Sets, wherein the PAP Line and angle also distinguishes the Sets—especially the low angled Sets.

GC MEHC energy formations constitute enormous advantages: a) even an open mouth Inlet of a single cell very primitive organism is evolving and highly functional; b) said outlet DCSS a First Sub-outlet, in a rounded cross-section greatly narrowed breadths, can pass a largest particle, raise initially a hydrostatic pressure, while assisting to restrict it, to positively submerge said transition region said undersurface, with a Second Sub-outlet and a Third Sub-outlet, which effectuate light hydrostatic pressures, comprise means for a positive connection to a vent line stack which avoids suction, and forces fluids said ND open channel flow into a drainage line; c) said low hydrostatic pressure lowers friction or energy of distortion passed into boundaries, retaining greatest velocity flows; d) said Fluid Elements, GC cross-sections with optimal Inlet least height, constitute a least energy of distortion, hoop stresses, in boundaries, for optimal longevities; e) said Fluid Elements functions pass nonhomogeneous, nonuniform and nonsteady fluid, precluding suction or venting, by the fluid quanta least volume limit seal of the undersurface and boundaries and light pressures least frictional losses; f) shortest shallowest PPLD form bands, illustrated in FIG. 1A and FIG. 1B.

GC conforming embodiments said sui generis boundaries bind greater cross-sectional areas than Inlet cross-sections, preclude suction, and connect to a vent stack; lower conduits cross-sectional areas embody narrow breach rounded lower surfaces of PPLD band widths and short and gradual slopes and high density fluids flow with transition region submerged crucial undersurfaces; a GC lower form effects lower conduit spout cross-sectional area forms that extend PPLD band widths, embodying a form of lower conduit with fluids wherein said undersurface infinitesimally highest increment resides in the fluid quanta with no reliance on fluids adhesion and surface tension; said lower conduit contains fluids up to a higher elevation of one of these: said highest increment; the sui generis boundaries a lower round portion springing points—see FIG. 27. The transition region extends from said lower conduit springing points to a cross-section of said sui generis boundaries the rounded upper area springing points. A lower retention comprises said fluids and solids fluid up to an elevation of an upper retention; the upper retention comprises said fluids and solids fluid from and including an elevation of said undersurface in said quanta to an elevation of the summit in the DCSS, with no reliance on said fluid surface tensions and adhesion; a detention constitutes said fluid above the upper the upper retention. An outlet ascending spout effectuates the summit, comprising: a horizontal infinitesimal length and infinitesimal width across the PPLD band; such width form, constituting the DCSS infinitesimally furthest from the Inlet; a free surface elevation at-rest of the upper retention; and said horizontal infinitesimal length and width lowest increment of the DCSS. The lower, the upper retention and the detention embody the fluid quanta bounded by said the generis boundaries extended into the DCSS, as a minimum. Said PAP Line and angle locates the fluid quanta vertical plane of symmetry, constituting the PAP Line two tangent points with no intersection—a point to the PPLD band and a tangent line to a globose End 2 or a globose inverse First End, spawning the PAP Line angle less than 180°, in respect to the gravity direction.

The upper retention largely comprises a truncated form of one of these: a globose, a spheroidal, a cylinder, an ellipsoidal or a cylindroid figure comprising a height less than its width or its length; Said globose End 2 or globose inverse First End undersurface is disposed in proximity of ½ half of a lower retention and a lower conduit constituted heights within the breadths of the sui generis boundaries region that transports high densities nonhomogeneous, nonuniform, unsteady flowing fluids; said breadths effectuating highest density fluids mass centroid higher elevations than in an equivalent cross-sectional area of an entirely rounded conduit forms, wherein transporting of said mass centroid effectuates transports of all flowing fluid mass through the lower conduit; the mass centroid PP comprises a shallower and a shorter length of the mass centroid PP than said entirely rounded cross-section can comprise. That, along with PPLD band genres comprising fluids mass disposition at highest elevations with highest potential energy and least energy demand, results in the GC Set over two magnitudes perfection over said best simple trap, when all effects are totted.

That, at root levels, extends to homogeneous fluids under high temperatures and/or pressures and said PMII technologies, all of which undeniably establish that the entire prior art is dysfunctional or obsolete in some fashion, especially when it comes to innate and AGW global air warming. It is a scientific fact—fluids, especially light fluids, not human dispositions rule the Universe, Earth.

A PPLD band length, including band length all discontinuities, corresponds to an entire length of said band on GC Set basin and outlet forms lowest surfaces length upon which said band resides. A Set PPLD band and a globose End 2 or a globose inverse First End undersurface taken tangent line comprises PAP Line, upright plane symmetry of the Set PPLD band of Set associated forms.

An End 2 Nozzle constitutes FESD forms and an integral part of Inlet End 2 submerged portions; Fluids quanta interface with an outlet—Sub-outlet, DCSS, PPLD band and light slopes and FESD forms, in rounded lower conduit and transition and rounded globose regions cross-sectional areas composite boundary which consists of these: rounded, curvilinear, elliptical and parabolic forms.

FIG. 1 of the drawings shows a cross-section side elevation view taken generally about an upright plane of symmetry of a visualized schematic of genus parent. Section A-A of the FIG. 1 is almost never innately entirely round but comprises such cross-sections for homogeneous uniform fluids. Said parent illustrates elongated outlet that reduces to orifice forms, as in one cell organisms that also reveal open mouth Inlets; an enhanced schematic cross-section of the First Element, said sui generis boundaries of a nonhomogeneous, nonuniform, and nonsteady fluids, FIG. 27 illustrates.

FIG. 1A illustrates cross-sectional view taken generally through a PAP Line and upright plane of symmetry as comprising a schematic of globose domain genus Second Fluid Element invention. FIG. 1B shows schematic of the prior art simple trap cross-sectional view taken generally about upright plane of symmetry. Supra detail dramatic physical genres differences that are stunning.

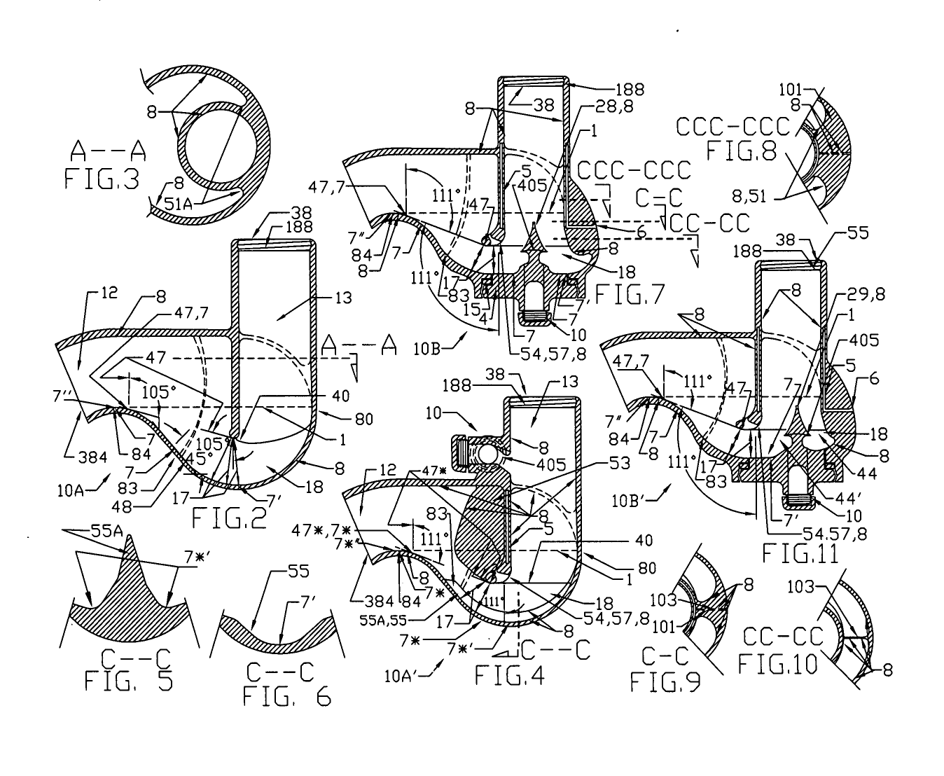

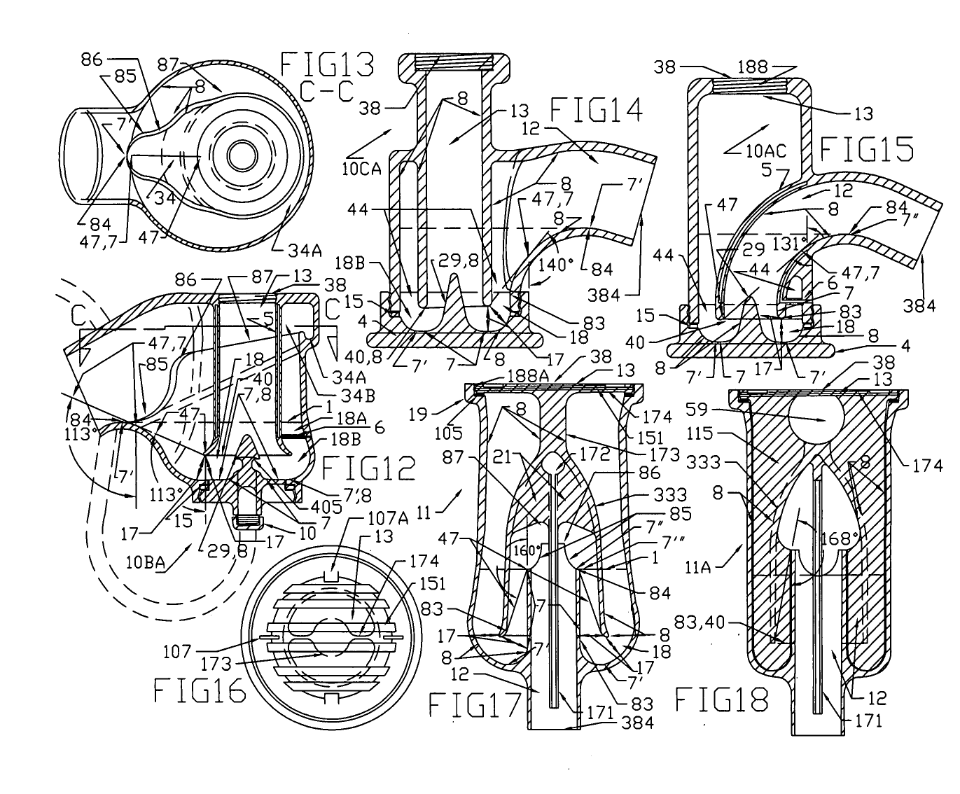

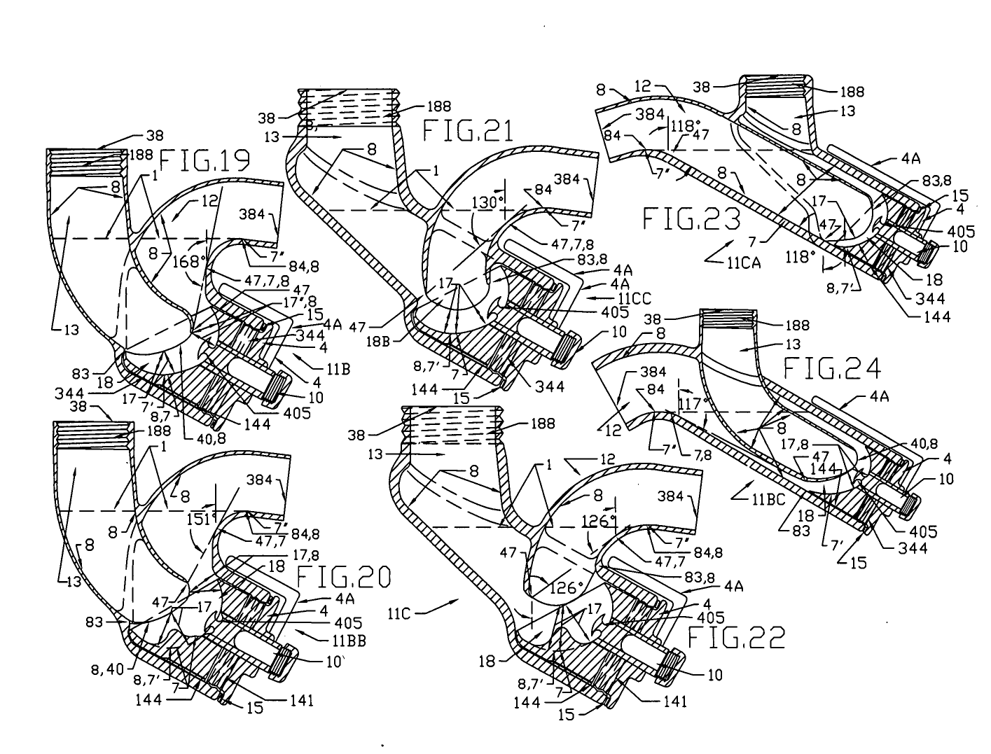

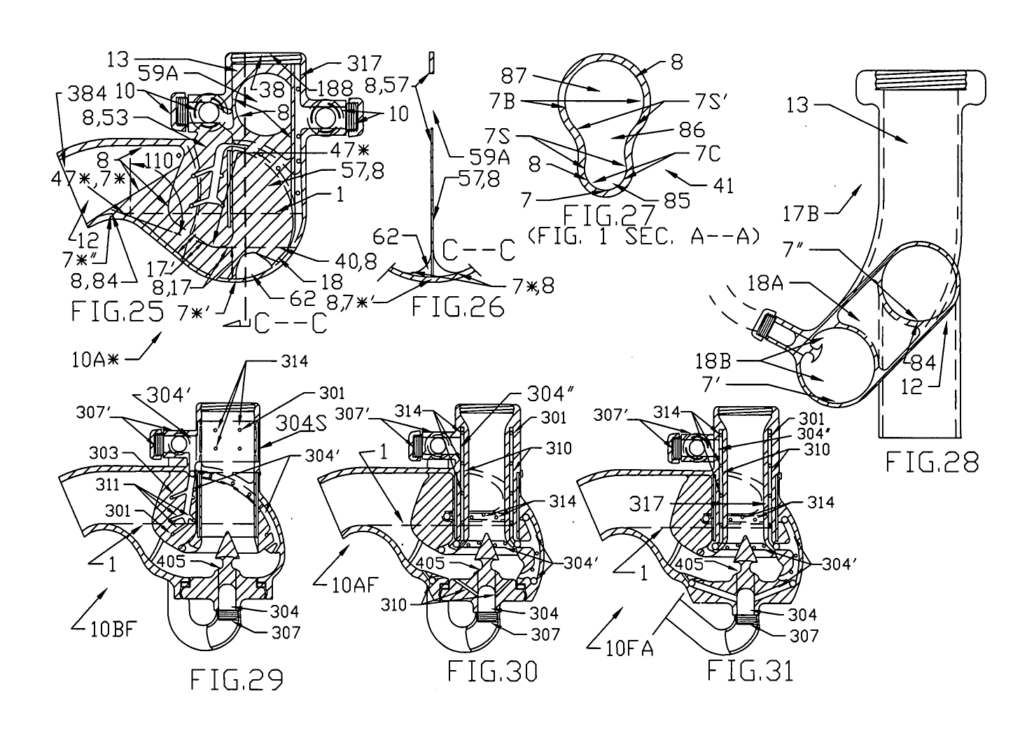

In operation, the Second Fluid Elements, Sets, as shown in FIG. 2 through FIG. 32 function quite similarly, same ways, especially in operation associated with the fluid boundaries perfection and the sui generis boundaries that embody inner surfaces of each Set; dissimilarity in function, form and structure is specifically identified and explained. Consequently, most fundamental structure of Set 10A is utilized as a paradigm of forms, function and structure to explain, describe the Sets. Globose domain Sets comprise the undersurface of the End 2, while globose inverse domain Sets comprise the undersurface of the First End and potential suction, requiring attention by necessity.

The fluid boundaries perfection associates with the film layer and, therefore, with the PPLD band and the FESD forms and surfaces, and the DCSS, the summit, the undersurface in the quanta and the sui generis boundaries, to nearly infinitesimal exactitudes of a Set structure as supra describe.

Exactitudes of fluid quanta boundaries perfection and the sui generis boundaries 8 constitute the fluid quanta these: fluid Inlet 13, End 1 and End 2, and fluid outlet 12, First End, DCSS 84, and Second End; and basin 18, Inlet 13 and outlet 12 fluid quanta, fluid free surfaces 1, summit 7″, Separations 17; and either globose or globose inverse domain distinguishing End 2 undersurface 40 or First End undersurface 83 comprising FESD forms and surfaces a minimal configuration.

Second Fluid Element, Globose Sidelong Set 10A as shown in FIG. 2-3 comprising fluid Inlet 13, fluid outlet 12, and fluid basin 18, with the fluid quanta in said Inlet, basin, and outlet, constitute fluid boundaries perfection, the film layer and sui generis boundaries 8 inner surfaces of the Set 10A, Cavity 51 and said FESD forms and surfaces minimum; the fluid quanta embodies the fluid free surfaces 1 fluxing range, as the quanta, the sui generis boundaries flux as one boundary; as it will be understood, the Set is positioned to receive fluid from a system requiring a drain line and may be fabricated as supra describe and as is known in the art.

Fluid Inlet 13 is shown in FIG. 2 as comprising End 1 38 threaded region 188, and inflection point 80 about basin blind side 80, and rounded fine End 2 undersurface 40, comprising an FESD form convex curvature. It will be understood that said undersurface 40 may likewise comprise other End 2 undersurface 40 FESD forms as shown in other Sets. Threaded region 188 is configured to accept standard size pipe threads. Specialty threads which may comprise outer and/or inner windings are contemplated for use. Positive connection threaded region 188 is shown; it should be understood that the connections may comprise a slip type joint or other connections such as a welded connection, among others, some of which may additionally require a slip nut and gaskets. Supra further describes contemplated connections.

The fluid quanta spawn PPLD band 7, from rounded lowest form 7′ to First End 83, extending into outlet 12 portion of the fluid quanta, into summit 84 and DCSS FESD forms and summit 7″, PPLD band 7 gradual narrowing of width into summit 7″ and—similar to FIG. 1—smooth S PPLD band 7 rounded form lowest form 7′, comprising PPLD band 7, and thus basin the fluid quanta and the sui generis boundaries 8 at highest elevations—effectuated by fluid Inlet 13 short height yet comprising inflowing fluid sufficient potential energy.

Fluid outlet 12 is shown in FIG. 2 as comprising entry region at First End 83, ascending spout region to summit 7″, comprising DCSS FESD 84 forms finite increment, and descending spout to Second End 384, outflow region, which is configured to accept a standard size pipe which may comprise inner or outer socket for welding. Just as with fluid Inlet, the outflow region may comprise a standard pipe thread which may be internal or external; other types of connections as is known in the art, such as those with respect to the Inlet are likewise contemplated for use. As an integral part fluid boundaries perfection and the sui generis boundaries, an ascending spout of fluid outlet 12 comprises cross-sections bounded areas which align into said DCSS FESD forms, effectuating the First, Second and Third Sub-outlets of the fundamental Fluid Elements, wherein supra describe and drawings of the Sets illustrate and enumerated the Sub-outlets and areas. The Sub-outlets of the Set 10A comprise: the First, the Second, and the Third Sub-outlet forms taken respective lower ¼, lower ½ to lower ¼, and upper half of cross-section height bounded areas, in FESD forms of the DCSS; enhanced such respective heights and areas delineation FIG. 27 shows.

As a paradigm of Second Fluid Elements genus, Set 10A is shown as comprising the fluid quanta portions enclosed in said Inlet, basin, and outlet. The fluid boundaries perfection yielding the sui generis boundaries 8 as inner surfaces of the Sets, whereas structure of Set 10 comprises the PAP Line and 105° angle 47, in respect to gravitational direction.

The fluid fluxing quanta comprises a fluxing range from free 1 surface at rest to dispositions high in the basin, above which in globose domain the fluid free surface rising is limited, as fluid Inlet 13 comprises a cross-sectional area about 50% smaller than a cross-sectional area of outlet 12. Should the fluid fill up the basin, said venting line or device, which positively precludes suction, precludes suction as the fluid free surface enters from the system into the Inlet, as outflow rate in the outlet exceeds outflow rate thru the End 2. The fluid quanta bound by sui generis boundaries exactitude constitute a physical barrier of fluid between free surface 1 and undersurface 40. The barrier comprises a margin of safety which precludes fluxing flowing fluids angular momentum, in upright plane, of dropping elevation of free surface to elevation of said highest increment—the finite, nearly infinitesimal detail—of the undersurface. Said least volume limit of the fluid quanta embodies the physical barrier effectuated by the fluids.

Said lower conduit spout cross-sectional area forms that extend PPLD band widths, embodying a form of lower conduit with fluids wherein said undersurface infinitesimally highest increment resides in the fluid quanta with no reliance on fluids adhesion and surface tension comprises least separations 17 between undersurface 40 of a rounded End 2 FESD form and the PPLD band with a cross-sectional area capable of easily passing largest solid particle or particles.

The Set 10A is shown as capable of accepting the fluid quanta associated FESD forms inside the sui generis boundaries of the Inlet 13, basin 18 and outlet 12. The Sets that follow illustrate and describe numerous FESD forms in various configurations, as such forms readily configure into a Set. The FESD forms lower the fluid quanta volume without impacting said physical barrier and margin of safety, while minimizing the fluid random rotations, especially in horizontal reference planes, and lowering the PPLLS to configuration of said PPLLS absolute least sum, genome Set.

Where necessary, said Flush Apparatus, which supra describe and as may be required in various configurations are shown as paradigms embodied in the following Figures of selected Sets—said Apparatus can comprise a tie-in or tie-ins anywhere on a structure of a Set, in configurations and with parts not limited to those described and illustrated in the Sets. The Flush Apparatus various operations are controlled from a tie-in apparatus associated with the Set. Fluid 13 Inlet may also include an auxiliary input, such as one from dishwasher, to a designated tie-in port. Each tie-in is shown with a cap, which is removed to make connection, supra describe. Reference numerals that identify designated Flush Apparatus parts are as shown in FIGS. 29-31.

Likewise, a cleaning member, Cap or a Plug, is illustrated in numerous Sets, wherein respective Set cleaning member is threaded into basin 18 structure and comprising basin lowest surfaces sui generis boundaries; by rotating the cleaning member, the cleaning member can be removed, thus revealing components of the Set; then, the Set inner components can be cleaned, or even flushed, or repaired. Most cleaning members are shown as comprising a major nozzle, as a component of a Flush Apparatus. The major nozzle comprises housing, which also can be utilized as a handle; cleaning member markings assure that the cleaning member is threaded-in in correct orientation. Angled Sets cleaning members are shown as comprising an assembly of Filler Member and Plug, referenced by one number, a locking key, and said major nozzle, which can be removed by first unscrewing the Plug, to removing the locking key and the Filler Member, revealing components.

Said sui generis boundaries shown as constituting structure failure detection means, as are shown in FIG. 4 and others, constitute dual walls with space 5, passage and orifice 6 for downward flow, separating in globose domain the fluid in Inlet 13 or, as FIG. 15 showing, or in globose inverse domain fluid outlet 12 from the fluid in basin 18. A small downward drip provides a warning.

In operation, it is necessary to first align and configure the Set connection parts, prior to welding said socket of the outlet to a drainage line system and prior to connecting the Inlet to a system of various functions supplying waste fluid. Connections shown—one threaded and the other welded—show two examples, only. Multitude of other attachments, connections is contemplated for use. Once fully attached into the system, the apparatus is ready for use. When the fluid is introduced through the Inlet, it will submerge said undersurface for entire lifespan of the Set, and any excess of the fluid, unless said Plug or Cap is removed for maintenance. The fluid above the summit set fluid free surface at rest elevation will outflow through the outlet; fluid flowing thru the Set, said sui generis boundaries, will comprise the film layer and boundaries perfection, thru DCSS forms.

Inasmuch as said summit constitutes higher elevation that the undersurface said highest elevation with said margin of safety, the fluid in retention will effectuate the physical barrier between fluid Inlet 13 and fluid outlet 12, which thus prevents odors from returning thru the fluid in the outlet and basin into the fluid in the Inlet. Should in situ conditions indicated that clogging may occur, but very rarely, various Flush Apparatus assemblies with said means, which supra describe, and even said cleaning member, Cap or Plug, are readily configured into a suitable Set configuration.

Supra and Set 10A explanation of genus genres fundamental forms and function that distinguish genus comprise substantive aspects of subsequent Sets and explanations, including embodiments, assemblies, and elements not illustrated with the Set 10A.

With reference to the following explanation of subsequent embodiments, assemblies, and elements having like function or structures are shown with like reference numerals.

Set 10A′ as shown in FIGS. 4, 5 and 6 as shown in FIG. 4 side elevation view in upright plane of symmetry, comprises End 2 undersurface 40 Infant Boot 54 and these FESD forms and surfaces associated with the sui generis boundaries 8, in addition to the minimal configuration: for Ridge 55A as shown in FIG. 5, and two PPLD bands 7* two lowest rounded forms 7*′ and two PAP Lines 111° angles 47* and one of each in two hyperbolic upright surfaces that approach tangency in passing First End 83, and for Trough 55 as shown in FIG. 6 single PPLD 7*′ single basin lowest rounded form 7*′ and single PAP Line 111° angle 47*, wherein the two PPLD bands and forms individually comprise narrower widths than said single band and forms, and Fin 53, and Nozzles 57. Genres of forms associated with hyperbolic planes reveal circumferential strain, which distinguishes Set 10A′ with Ridge 55A as a hybrid, wherein the two PAP Lines 47 and two PPLD 7*′ bands appear as one PAP Line and one PPLD band, in side elevation view. Nozzles 57 are symmetrically configured with one on each side of Fin 53. The Set shows dual wall 5, passage and orifice 6. Flush Apparatus in FIG. 4 embodies two tie-ins 10 and major nozzle 405—supra exactitudes and Set 10A, as paradigm, further explain the Set 10A′.

FIG. 7-10 shows Set 10B, End 2 undersurface 40 Infant Boot 54 disposed centric in fluid basin 18 and these FESD forms and surfaces associated with the sui generis boundaries 8, in addition to the minimal configuration comprising PAP Line 111° angle 47 in respect to gravitational direction: PPLD band 7 basin lowest annular valley 7′, basin blind side Bridging Wall 11, Plug 4 assembly Flush Apparatus 10, major nozzle 405, gasket 15 and conical form 29 which is optional since the fluid quanta would spawn such a form, dual walls 5 passage and orifice 6. Supra exactitudes and Set 10A, as paradigm, further explain the Set 10B.

Infant Boot End 2 undersurface 40 disposed centrically in basin 18 and offset centric in Inlet 13 as shown in FIG. 11, Set 10B′, comprises these FESD forms and surfaces associated with the sui generis boundaries 8 in addition to the minimal configuration comprising PAP Line 111° angle 47 in respect to gravitational direction; PPLD band 7, pitched basin 18, lowest surface crescent lowest form 7′, Dimensions 44, Plug 4 assembly Flush Apparatus 10, major nozzle 405, gasket 15 and conical form 29 which is optional since the fluid would spawn such a form, dual walls 5 passage and orifice 6. Supra exactitudes and Set 10A, as paradigm, further explain the Set 10B′.

Fluid Inlet 13 disposed centrically offset in fluid basin 18, outlet 12, of globose cylindrical Set 10BA, shown in FIG. 12-13 comprises these FESD forms and surfaces associated with the sui generis boundaries 8, in addition to the minimal configuration and PAP Line 111° angle 47 in respect to gravitational direction: Circumferential Trough 34A, Trough 34, Ridge 86 87, Partition 87, oversized fluid outlet 12, Tough-Ridge 34A-87, Trough-Ridge-Partition 34A-86-87, Ridge-Partition 86-87, Flared End 2 annular undersurface 40, and PPLD band 7 lowest annular form 7′; oversized outlet 12 extends topside of basin 18 comprising First 85, Second 86 and Third Sub-outlets 87, preclude suction an minimizes the angular momentum of flowing fluid; outlet 12 ascends as Trough 34 inside two circumferential Troughs 34A that descend about fluid basin 18; basin 18 about fluid Inlet 13 comprises circumferential Trough 34, Trough-Ridge 34A-87, Trough-Ridge-Partition 34A-86-87 and Trough-Partition 34A-87, which with fluid basin 18 and said outlet 12 three dimensional Window 34B, Plug 4 assembly, Flush Apparatus 10, major nozzle 405, gasket 15 and conical form 29 which is optional since the fluid quanta would spawn such a form; dual walls 5, passageway and orifice 6. Supra exactitudes and Set 10A, as paradigm, further explain the Set 10BA.

FIG. 14 shows globose cylindrical Set 10CA rounded End 2 undersurface 40 disposed centric in fluid basin 18 these FESD forms and surfaces associated with the sui generis boundaries 8, in addition to the minimal configuration and PAP Line 140° angle 47 in respect to gravitational direction: fluid outlet 12 ascending spout elliptical cross-sections, PPLD band 7 lowest form annular valley 7, said optional conical form 29, Dimensions 44, and Cap 4, requiring gasket 15 and comprising conical form 29, which is optional since the fluid quanta would spawn such a form—supra exactitudes and Set 10A, as paradigm, further explain the Set 10CA.

Fluid outlet 12 rounded First End undersurface 83 disposed centric in basin 18 of globose inverse Cylindrical Set, 10AC as shown in FIG. 15, comprises these FESD forms and surfaces associated with the sui generis boundaries 8, in addition to the minimal configuration and PAP Line 131° angle 47 in respect to gravitational direction: PPLD band 7 basin lowest annular valley 7′, Dimensions 44, and Cap 4 comprising a dual walls 5 and passageway 6 orifice; preferred forms of fluid outlet 12, First End undersurface 83, and DCSS 84 comprise the First Element classical cross-section genres as FIG. 27 shows. Variations in Dimensions 44 migrates First End undersurface 83 centric disposition from a sidelong to an anti-sidelong configuration. In situ, where suction is a concern, a nipple is threaded into outlet 12 crown, comprising an attachment and a passageway for a mechanical device that permits fluid inflow, only—supra exactitudes and Set 10A, as paradigm, further explain the Set 10CA.

FIG. 16-17, Set 11 as shown hollow conical Partition 333 lower flaring First End undersurface 83 disposed centric in fluid basin 18 around upright fluid outlet 12 disposed centric inside Partition 333 comprise FESD forms and surfaces associated with the sui generis boundaries 8, in addition to the minimal configuration: fluid basin 18 upright plane two summits 7″, as shown in FIG. 17, and, in respect to gravitational direction two PAP Line 160° angle 47 tangents of First End, two PPLD bands 7 annular valley lowest form 7′ in largely hemispherical fluid basin 18, and three dimensional DCSS 84, and fluid outlet 12 two First Sub-outlets 83, two Second Sub-outlets 84 diametrically opposed, and three dimensional Third Sub-outlet 86; fluid outlet 12 three dimensional partition 12A and said First 83 and Second 84 Sub-outlets as flow managers; inside and outside surfaces of three dimensional Partition 333 around inside and outside surface of fluid outlet 12 three dimensional Partition 12A and inside surfaces of fluid Inlet 13 respective flowing fluids three fluid managers; disposed centrically inside fluid outlet 12 upright perforated conduit 171, side plates 21 welded to Partition 333, and air volume 172 and side plates 21 three dimension windows 21A means for precluding suction, as further explained with FIG. 18. Partition 333 and fluid outlet 12, each can separately migrate in respect to fluid basin 18 and fluid Inlet 13, altering disposition of each. Fluid Inlet 13, Partition 333, and fluid outlet 12, each can separately rotate in two upright planes, constituting domain of Inline Sets. Fluid Inlet 13, End 1 38, rim 19 can be fixed to base fluid reservoirs, as is known in the art. Partition 333 and post 173, with treaded brass flange 174 strainer 151 and gasket 105 threads into rim 19, drop-in lock keys 107, 107A complete assembly shown in FIG. 16. Removing the lock keys and unthreading flange 174 exposes components for cleaning or repair. Supra exactitudes and Set 10A, as paradigm, further explain the Set 10CA.

FIG. 18 elevation view shown in FIG. 17 Set 11 as entirely cylindrical is rotated 90° in horizontal planet, showing two dimensional Partition manager 115 partitions fluid basin 18 and Inlet 13 into equal halves, and Partition manager 115 upper end rounded Window 59 as FESD forms and surfaces associated with the sui generis boundaries 8, in addition to the minimal configuration, and FESD Forms described with FIG. 17. Rising fluids level in one of two halves of fluid basin 18 and fluid Inlet 13, upon rising in one half of said 11A Set forms, flows through Window 59 into the other half of fluid Inlet 13, which effectuates Set 11 as comprising of two Sets. Partition manager is freely supported by basin lowest surfaces and is separated from treaded brass flange 174 strainer 151 and gasket 105 shown in FIG. 16-17. More than one Partition manager 115 is contemplated, wherein additional subdividing of Set 11 into separate cells, compartments, results in First End undersurface 83 transposing into function of End 2 undersurface 40; that transposing comprises Set 11 desirable limited partitioning, as the Set 11 is on globose and globose domains boundary. Each cell comprises Sidelong Set wherein one cell flows more fluid than other cells, prevents suction in one of the cells which avoids suction in all other cells, comprising means for opposing suction and splitting of the fluid quanta said angular momentum; enlarging Window 59 to receive a mechanical device that allows fluid inflow into air volume 172 thru a nipple threaded thru Post 173 affects perforated conduit 171 back-up, for in-situ conditions where needed. Supra exactitudes and Set 10A, as paradigm, and explanation of FIG. 16-17 further explain the Set 11.

Globose domain in-situ systems required angled Set 11B as shown in FIG. 19 comprises fluid free surface 1 under First End 38, highly curved fluid Inlet 13 Inlet comprising, counter curved convex finely rounded End 2 undersurface 40 disposed in approximately horizontal and in anti-sidelong disposition if fluid basin 18, barely displaced from under End 1 38, and nearly parallel with fluid basin 18 concave lower surface, and highly curved fluid outlet 12 from First End 83 which nearly parallels undersurface 40 and Second End 384 disposition passed upright position, PAP Line 168° angle 47 in respect to gravitational direction, PPLD band 7 rounded lowest form 7′, and Filler Member 344 in fluid basin 18 lower surfaces FESD forms and surfaces associated with the sui generis boundaries 8, in addition to the minimal configuration. Assembly of Plug 4 comprises: Filler Member 344, Flush Apparatus 10 major nozzle 405, locking key 144, gasket 15 and swivel handle 4A. Supra exactitudes and Set 10A, as paradigm, further explain the Set 11.

Globose domain in-situ systems required angled Set 11BB as shown in FIG. 20 is replica of Set 11B, comprising these FESD forms and surfaces as substitutes for those shown in FIG. 19: barely more pitched End 2 undersurface 40 modification and PPLD band 7 crescent lowest form 7′ of Filler Member—Plug 141. Supra exactitudes and Set 10A, as paradigm, and FIG. 19 explanation further explain the Set 11.

Globose inverse domain in-situ systems required angled Set CC as shown in FIG. 21 comprises fluid free surface 1 under End 1 38, highly curved fluid Inlet 13 Inlet, counter curved fluid outlet 12, comprising nearly horizontal, convex First End undersurface 40 centric disposition of inside fluid basin 18, barely displaced from under End 1, and nearly paralleling fluid basin 18 concave lower surface, and Second End 384 disposition passed upright position, PAP Line 168° angle 47 in respect to gravitational direction, PPLD band 7 rounded lowest form 7′, and fluid basin 18 Filler Member—Plug 344 lower surfaces as FESD forms and surfaces associated with the sui generis boundaries 8, in addition to the minimal configuration. Assembly of Plug 4 comprises: Filler Member 344, Flush Apparatus 10 major nozzle 405, locking key 144, gasket 15, and swivel handle 4A. Supra exactitudes and Set 10A, as paradigm, further explain the Set 11.

Globose domain in-situ systems required angled Set 11C shown as replica of FIG. 22, Set 11CC comprises these FESD forms and surfaces as substitutes for those shown in FIG. 21: modified First End undersurface 83 to sidelong disposition, with PPLD band 7, crescent lowest form 7′ of Filler Member 141, as FIG. 20 describes. Supra exactitudes and Set 10A, as paradigm, further explain the Set 11C.

Globose inverse domain in-situ systems required low angled Set CA, shown in FIG. 23, embodies fluid free surface 1 under End 1 38, highly curved fluid Inlet 13 Inlet in anti-sidelong disposition, low angled fluid outlet 12, convex nearly horizontal lower portion First End undersurface 40 in anti-sidelong disposition inside fluid basin 18, paralleling fluid basin 18 concave lower surface, and Second End 384 disposition passed upright position, PAP Line 118° angle 47, in respect to gravitational direction, and PPLD band 7 rounded lowest form 7′, and fluid basin 18 Filler Member and Plug 344 lower surfaces as FESD forms and surfaces associated with the sui generis boundaries 8, in addition to the minimal configuration. Assembly of Plug 4 comprises: Filler Member 344, Flush Apparatus 10 major nozzle 405, locking key 144, gasket 15, and swivel handle 4A. Supra exactitudes and Set 10A, as paradigm, further explain the Set 11.

Set 10* as shown in FIG. 25-26 as showing in FIG. 26 upright plane of symmetry side elevation view, comprises these FESD forms and surfaces associated with the sui generis boundaries 8, in addition to the minimal configuration: rounded disposed sidelong End 2 undersurface 40 merged into Partition 57, Fin 53, Ridge 317, and two PPLD bands 7* two lowest rounded forms 7*′ and two PAP Lines 110° angles 47* and one of each in two hyperbolic upright surfaces that approach tangency in passing First End 83. Genres of forms associated with hyperbolic planes reveal circumferential strain, which distinguishes Set 10* as a hybrid, wherein the two PAP Lines 47 and two PPLD 7*′ bands appear as one PAP Line and one PPLD band, in side elevation view. With the fluid inflowing randomly into one or the other side of the Partition will randomly flush with more of the fluid both halves of Set 10*, while capacity to pass the fluid would comprise equal passing of the fluid through both halves of the Set when level of the fluid rises to elevation of Window 59A, which comprises finely rounded edges. Window 62, likewise comprising rounded edges, assures that at least some of the fluid passing into both PPLD bands 7*. Set 10* comprises four tie-ins 10 and Ridge 317 and Partition 57 Flush Apparatus parts and one major nozzle 405 as comprising Flush Apparatus 10, which are referenced and identified in FIG. 29-31. Supra exactitudes and Set 10A, as paradigm, further explain the Set 11 CA.

FIG. 27 shows First Fluid Element 41 cross-section forms, which for illustration purpose enhance differences in cross-sectional view A-A from the prior art entirely round forms, constituting the sui generis boundaries 8 associated with nonhomogeneous, nonuniform, unsteady flowing fluids, which spawn boundaries perfection of fluid quanta. Generally, the cross-section forms constitute a three cross-sectional areas boundary—lowest, smallest or not larger than either one of the other two cross-sectional areas, cross-section 85, the boundary extended bounding a required transition region, cross-sectional area 86, and said boundary further bounds a cross-sectional area largest of the three, cross-sectional area 87, completing said boundary, which embodies optimal narrowing, complete complements of breadths; the boundary at highest suitable elevation bounding of cross-section 85 with said breadths raises centroid of highest specific gravity fluids, or keeps at highest elevations, comprising well narrowed breadths from invert 7, also as PPLD band, to an elevation, such as 7C. Cross-sectional area 85 generally and not always comprises springing points 7S, and cross-sectional area 87 that constitutes springing points referenced as 7B. First Fluid Element 41 cross-sectional areas boundary form is distinctive signature and, if you will Fluid Elements genus DNA, apparent in second Fluid Elements GC cross-sectional areas and first Fluid Element forms, perimeter genres which are essentially mandatory as FESD forms and surfaces, especially DCSS, spawning flowing fluids least and steady pressures. Stated boundary genres are indeed universal.

FIG. 28 shows Set 17B as circumferential strain reference, for it appears in hydroelectric turbines.

Flush Apparatus assemblies 10BF, 10AF, and 10FA, FIG. 29-31 shown, assemble and perform functions supra describe generally comprise as in FIGS. 4, 7, 11, 12, 19-25, and 28-31 Flush Apparatus associated with tie-in or tie-ins 10 and major nozzle 405 comprise Cap 4 or Plug 4 assemblies, which are shown in illustrated Sets. Flush Apparatus assemblies comprising these parts and elements: Sub-nozzles 301, sub-passageways 303, major nozzles 405, major passageways 304 304′ 304″ 304S, passageways 310 and respective branches set 307′ of tie-ins 10, set of sub-passageways branches 311, and sub-nozzles set 314 are available parts selectively pre-assembled. Flush Apparatus parts numerous assemblies inside conduit walls are simplified by molded fabrication. A tie-in or a set of tie-ins is only outstanding Flush Apparatus parts, visible on structures of Sets.

FIG. 32 shows globose Cylindrical Industrial Centric Set 10′, suitable in functions of low to very high hydrostatic pressures. Set 10′ constitutes Inlet 13, basin 18, and outlet 12, which can retain large volume, while Holding Chamber 12A can detain huge volume of the fluid quanta; End 1 38 can comprise a high pressure fluid universal joint whose angle settings can be oriented and fixed, in orientation and in respect to gravitational direction, wherein Set 10′ embodying the sui generis boundaries 8 in specific settings, in addition to the minimal configuration, comprises these FESD forms and surfaces: End 2 undersurface 40, fluid outlet 12 First Sub-outlet 85, Second Sub-outlet 85 and Third Sub-outlet 36, summit 7′ DCSS 84, Holding Chamber 12A and Second End 384. In fluid outlet 12, fluid free surface 1 above summit 84 unifies fluid quanta retained in Set 10′; thus, further rises in fluids free surface level further subdues high pressure fluids oscillation dynamics.

Holding Chamber 12A readily accepts, at highest elevations—fluid inflow only—check valve; in very rare in situ conditions would Set 10′ require such check valve. Second End 384 is shown in upright disposition, wherein horizontal disposition is likewise contemplated, including a Holding Chamber that encircles Set 10′ as one assembly. Assembly of Plug 4 embodies: Flush Apparatus 10 major nozzle 405, locking key 144, gasket 15 and swivel handle 4A.

Set 10′ constitutes selected components of Set 10A, shown in FIG., primarily magnified along upright axes, such as fluid Inlet 13 and fluid outlet 12 whose summit 7′ DCCS 84 is additional subdivided, wherein fluid 12 descending spout embodies Holding Chamber 12A. Thus, Set 10A embodies and condenses all genres of Set 10′, wherein, in turn, FIG. 1 schematic does it better for all fundamental genres of globose domains strain, dominating as parent of Fluid Elements genus.

What is claimed is:

1: An Advanced Processor magma, mantle function and magnetic field lines couple mantle-coupled groundwater, polar caps and glaciers, less couple oceans with continental waters, partly decouple atmospheric fluids and least couple ionosphere ions and electrons mass, in magnetosphere bound compositions mass of light fluids quanta; light fluids magnetosphere perfect boundaries mass and energy highest conserving (MEHC) quintessential core natural disposition (QCNDMEHC) yields boundaries complete compliments, stressed by volume changes energy of distortion; bound mass fluid compositions force stratifications, gradations, and forbidden mechanisms, to distort, deform and distend dispositions of perfect boundaries complete complements and force Jean's fountains, forbidden mechanisms plasma outflows; innovations, inventions, principles, methodologies, Ions and Isotopes (FEIIPMII), genus Fluid Elements and the Advanced Processor, by quantum energy spawn perfect boundaries and sui generis boundaries, in high technologies algorithms computing principles, methodologies, innovations, and inventions (PMII), boundaries perfection tracings for globose conduit Sets, as in Advanced Processors, Advanced Fluid Elements; genus genres shown boundaries yield the suit generis boundaries and genres of genus that constitutes domains of Sets; fundamental Fluid Elements and the Fluid Elements comprising the sui generis boundaries and a ubiquitous clustering of the sui generis boundaries own solely key means for crucial reliefs, from global energy demands, water depletions, and innate and anthropogenic global warming (AGW); the FEIIPMII with the PMII and the Fluid Elements in clusters spawns means for combating the magnetic field lines recurring disconnects at shoulders of cusps that innately experience suctions.

2: The Advance Processor of claim 1, mass and energy field cannot entirely decouple from the Universe, Black Hole and the Milky Way Galaxy celestial bodies, gravitational fields of light fluids energy sinks; said fluid mass energy fields cannot avoid constellation radiations and wind pressures effect; the Earth geology stratigraphic records of solidified fluids mass reveal: magma flows and polar caps and glaciers ground displacements and mantle gradations and stratifications decoupling processes groundwater changes; thus, recorded nearly entire geological and erosional history supplements the Earth fluids innate magnetosphere boundaries revealed a globose inverse offset centric Set, in fluid energy boundaries short period effects, which documents conclusively: a) triatomic vapors, raising globally air temperatures, force Jean's plasma fountains crucial fluids released to space; b) the Earth Advanced Processor spawns electromagnetic field magnetosphere by constituting the ionosphere an enlarged volume, emitting persistently plasma mass and energy to space; c) the Advance Processor inherent mass energy solidifying processes spawn the mantle volcanic activities, tectonic movements, and energy of distortion and volume change greenhouse gases emission; d) the Processor moderates atmospheric temperatures with fluids energy volume.

3: A sui generis boundaries flux of fluxing fluid quanta achieves fluid boundaries perfection and sui generis boundaries means for flowing fluids and solids fluid in Second, First Fluid Elements with respective drain traps, lines functioning and embodying the fluid quanta: least volume limit and a short height, short length surface areas smallest sum, free surfaces area maximal sum, hydrostatic light pressures, and completely matching complete complements of globose-conduit (GC) forms, at highest elevations; quantum mass and energy subdivides said quanta, constituting—concurrent quantum energy tracings of paths of passage (PP), deriving a PP least sum (PPLLS); a path angle of passage (PAP) Line comprising an angle of less than 180°; and lowest path of passage, path of passage of least energy demand, a PPLD, a PPLD band comprising forms, a mass energy highest conserving (MEHC) and the fluxing fluid quanta with sui generis boundaries and a film layer, an inductive component, on inner surfaces of Sets as the sui generis boundaries an interface with the quanta. In globose domain, a Set comprises—a fluid Inlet capable of inflowing fluid, a basin and an outlet and means for retaining fluid; a lower end of the Inlet, an End 2; an End 2 undersurface, disposed in the quanta; an upper end, an End 1 of the Inlet; and said outlet capable of discharging fluid thru an outflow, a Second End, of the outlet. In globes inverse domain, a Set comprises—a fluid Inlet capable of inflowing fluid, a basin, and an outlet and means for retaining fluid; a lower end of the Inlet, an End 2, a basin, outlet form an upper end; an End 1, an upper end of said Inlet; in said basin, a front end, a First End, of the outlet; and an undersurface of the First End disposed in the quanta, the outlet capable of discharging fluid thru an outflow, a Second End, of the outlet; a globose and circumferential strains hybrid domain mutations, migrations Set comprises—a fluid Inlet capable of inflowing fluid, a basin, an outlet and means for retaining fluid; an upper end, an End 1, and a lower end, an End 2, of said Inlet; a front end, a First End, and an outflow, a Second End, of the outlet capable of discharging fluid; and in the quanta, disposed an undersurface of the End 2 or the Second End, and migrations, mutations matched genres of said strains in the Set; in domain, the undersurface in the quanta, without said film layer, comprises the fluid fluxing fluids retention free surface lowest level and the limit of the quanta least volume; a summit in the outlet constitutes means for retaining the fluid and the fluids entire quanta associated in retention, in the Inlet, the basin, and the outlet; flow energy surface dispensing (FESD) surfaces and FESD forms, comprising flow control means and including the film layer, lower the PPLLS; the PPLLS lowest sum comprises genome; the sui generis boundaries as surfaces, in an upright plane cross-section bound breadths of a nominal rounded lower area, widening breaths of a transition region area and wide breadths of a rounded upper area comprise a cross-section boundary of said Sets, drain lines respective forms; said undersurface comprises means for precluding a gas venting thru the Inlet; the First and the Second Fluid Elements comprising Fluid Elements fundamental Fluid Elements possess means for venting gases inside the basin, comprising a venting line or a substitute device that positively precludes suction of the fluid that constitutes said least volume limit of the quanta.

4: The Advanced Processor magma and mantle with magnetic field functions of claim 1, wherein the Earth and the magnetosphere mass energy fluids constitute that Advanced Processor, of evolving mass energy thru billions of years, spawned magnetic field functions that shield light fluids quanta comprising: light ions and isotopes and molecular fluids and living organisms mass densities that effect magnetic field lines two magnetic poles formed two funnel cusps through the ionosphere and electrically charged stratosphere; the magnetic field lines constitute a GC globose inverse offset centric Set perfect boundaries that flux violently under Solar and cosmic radiations and wind pressures; frictionless flowing fluids in the cusps in one of two funnel directions spawn each cusp functions either as an open mouth branch Inlet or an orifice outlet jointly or separately, in perfect boundaries retained plasma densities causal effects response to said pressures; the cusp shoulders constitute forms of the End 1 or the Second End, depending on plasma flows direction; in situ, the Fluid Elements spawn completely matching complete complements, GC Sets, and the clustering of the sui generis boundaries effect light fluid genres, in revolutionary fluid mechanics quantum energy aspects tracing replicas of said magnetosphere perfect boundaries and longevity.

5: The Sets of claim 3, wherein the End 2 or the First End undersurface lodged in the quanta, inside the basin, distinguishes among the Sets and domains; symmetry of said basin or the outlet in a curved upright surface distinguishes hybrid Sets and mutations in globose or globose inverse domain; a disposition of the undersurface in the basin likewise differentiates Sets within domain; a Holding Chamber of the outlet, comprising means for inflowing the fluid from FESD forms of the outlet and capable of catching transient retention of the fluid and capable of the fluid outflow, distinguishes Industrial Sets; an Inlet conical FESD duel form, a part of the outlet, distinguishes Inline Sets; dispositions of the End 1 in respect to the basin further distinguish Sets, and relative magnitudes of constituted respective angles of the PAP Line distinguish among angled Sets, also.

6: The Advanced Processor of claim 1, wherein
Black Holes' streaming mass energy demands, MEHC, and magnetic and gravitational fields rule the Universe with densest mass energy densities dominating at confronting perimeter boundaries; Said fountains light fluids plasma outflows, thru the magnetic field cusps, pay with highly valued commodities—nitrogen and water based ions that constitute outflows plasma; strongest magnetic field, and gravity sink, least volume ionosphere densest light fluids boundaries are a forced must.

7: The Advanced Processor of claim 1, wherein
the FEIIPMII and PMII technologies synchronous GC Sets operations with the Earth Advanced Processor and the SP transfers of heat energy that deflate distending of magnetosphere perfect boundaries, thus shielding the Earth fluids, comprise this civilization survival true option; this application, with the listed priority data applications, compiles and validates undeniable key evidence that the FEIIPMII, PMII, and MEHC versions comprise high technology universal fluid mechanics revolutionary true innovations that constitute our civilization only chance for survival, the civilizations recourse constitutes en mass implemented the FEIIPMII, PMII, and MEHC true and revolutionary devices technology and principles, methodologies, innovations and inventions; the Fluid Elements, the SP in the FEIIPMII combat, oppose scramble stratifications, gradations forbidden mechanisms processes.

9: The sui generis boundaries flux of fluxing fluid quanta of claim 3 comprising a Flush Apparatus embedded in walls of structure associated with said sui generis boundaries, avoid interconnecting fittings by interconnecting embedded portions of said Flush Apparatus and welding molded parts of the structure, thus assembling said Flush Apparatus and the structure of a Set; a tie-in or a set of tie-ins comprising compression fittings associated with the Flush Apparatus, disposed at most advantages location on the structure, connects said Flush Apparatus to tie-in apparatus means for delivering specifically designed fluids to the Flush Apparatus at selected flow rates and pressures and in preselected quantities; said Flush Apparatus, inside a Set, constitutes strategically located means for rinsing, flushing and servicing of the film layer of said sui generis boundaries, wherein said means comprise broad varieties of spray nozzles, with a nozzle face flush with the structure.
